(19) United States
(12) Patent Application Publication
(10) Pub. No.: US 2020/0338531 A1
(43) Pub. Date: Oct. 29, 2020

(54) PROCESS FOR PREPARATION OF A SPECIFIC CATALYST FOR SELECTIVE HYDROGENATION AND HYDROGENATION OF AROMATIC COMPOUNDS BY KNEADING

(71) Applicant: IFP Energies Nouvelles, Rueil-Malmaison (FR)

(72) Inventors: Malika BOUALLEG, Villeurbanne (FR); Anne-Claire DUBREUIL, Lyon (FR)

(73) Assignee: IFP Energies nouvelles, Rueil-Malmaison (FR)

(21) Appl. No.: 16/962,102

(22) PCT Filed: Jan. 2, 2019
(86) PCT No.: PCT/EP2019/050025

§ 371 Date: Jul. 14, 2020

(30) Foreign Application Priority Data
Jan. 15, 2018 (FR) 1850280

(51) Int. Cl. B01J 23/755; C10G 45/36; C10G 45/48; C10G 45/60; B01J 35/10; B01J 37/04; B01J 37/02; C01F 7/02

(52) U.S. Cl. CPC B01J 23/755; C10G 45/36; C10G 45/48; C10G 45/60; B01J 35/1014; B01J 35/1019; B01J 21/04; B01J 35/1061; B01J 35/1076; B01J 37/04; B01J 37/0236; C01F 7/021; B01J 35/1038

(57) ABSTRACT

Preparation of a catalyst comprising an oxide matrix and an active phase comprising nickel: —a calcined porous aluminium oxide is prepared; —the calcined porous aluminium oxide obtained is kneaded with a solution resulting from mixing one or more solution(s) of at least one nickel precursor and at least one solution of at least one organic compound which has at least one carboxylic acid function, or at least one alcohol function, or at least one ester function, or at least one amine function, or at least one amide function, in order to obtain a paste, wherein the mole ratio of said organic compound to the nickel element is between 0.01 and 5.0 mol/mol; —the paste obtained is shaped; —the shaped paste obtained is dried at a temperature of less than 250° C. in order to obtain a dried catalyst.

### TECHNICAL FIELD

A subject-matter of the invention is a specific process for the preparation of a catalyst used in the selective hydrogenation of polyunsaturated compounds in a hydrocarbon feedstock, in particular in C2-C5 steam cracking fractions and steam cracking petrols, or in the hydrogenation of at least one aromatic or polyaromatic compound present in a hydrocarbon feedstock, making possible the transformation of the aromatic compounds of petroleum or petrochemical fractions by conversion of the aromatic nuclei into naphthenic nuclei.

### PRIOR ART

The most active catalysts in hydrogenation reactions are conventionally based on noble metals, such as palladium or platinum. These catalysts are used industrially in refining and in petrochemistry for the purification of certain petroleum fractions by hydrogenation, in particular in reactions for the selective hydrogenation of polyunsaturated molecules, such as diolef ins, acetylenics or alkenylaromatics, or in reactions for the hydrogenation of aromatics. It is often proposed to replace palladium with nickel, a metal which is less active than palladium. It is thus necessary to have it available in a greater amount in the catalyst. Thus, nickel-based catalysts generally have a metal content of between 5% and 60% by weight of nickel, with respect of the total weight of the catalyst.

The rate of the hydrogenation reaction is governed by several criteria, such as the diffusion of the reactants at the surface of the catalyst (external diffusional limitations), the diffusion of the reactants in the porosity of the support towards the active sites (internal diffusional limitations) and the intrinsic properties of the active phase, such as the size of the metal particles and the distribution of the active phase within the support.

As regards the internal diffusional limitations, it is important for the pore distribution of the macropores and mesopores to be appropriate for the desired reaction in order to provide for the diffusion of the reactants in the porosity of the support towards the active sites and also for the diffusion of the products formed towards the outside.

As regards the size of the metal particles, it is generally accepted that the catalyst becomes more active as the size of the metal particles decreases. Furthermore, it is important to obtain a distribution in size of the particles which is centred on the optimum value and also a narrow distribution around this value.

The often high content of nickel in the hydrogenation catalysts requires specific synthesis routes.

The most conventional route for the preparation of these catalysts is the impregnation of the support with an aqueous solution of a nickel precursor, generally followed by a drying and a calcination. Before they are used in hydrogenation reactions, these catalysts are generally reduced in order to obtain the active phase, which is in the metallic form (that is to say, in the zero valency state). Catalysts based on nickel on alumina prepared by just one impregnation stage generally make it possible to achieve nickel contents of between 12% and 15% by weight of nickel approximately, depending on the pore volume of the alumina used. If it is desired to prepare catalysts having a higher nickel content, several successive impregnations are often necessary in order to obtain the desired nickel content, followed by at least one drying stage and then optionally by a calcination stage between each impregnation.

Thus, the document WO2011/080515 describes a catalyst based on nickel on active alumina in hydrogenation, in particular of aromatics, the said catalyst having a nickel content of greater than 35% by weight, with respect to the total weight of the catalyst, and a high dispersion of the metallic nickel over the surface of an alumina having a very open porosity and having a high specific surface. The catalyst is prepared by at least four successive impregnations. The preparation of nickel catalysts having a high nickel content by the impregnation route thus implies a sequence of numerous stages, which increases the associated manufacturing costs.

Another preparation route also used to obtain catalysts having a high nickel content is coprecipitation. The coprecipitation generally consists in simultaneously running both an aluminium salt (for example aluminium nitrate) and a nickel salt (for example nickel nitrate) into a batch reactor. The two salts precipitate simultaneously. A high-temperature calcination is then necessary to bring about the transition of the alumina gel (for example boehmite) to alumina. Contents of up to 70% by weight of nickel are achieved by this preparation route. Catalysts prepared by coprecipitation are, for example, described in the documents U.S. Pat. Nos. 4,273,680, 8,518,851 and US 2010/0116717.

Finally, the route of preparation by cokneading is also known. Cokneading generally consists in mixing a nickel salt with an alumina gel, such as boehmite, the mixture produced being subsequently shaped, generally by extrusion, then dried and calcined. The document U.S. Pat. No. 5,478,791 describes a catalyst based on nickel on alumina having a nickel content of between 10% and 60% by weight and a size of nickel particles of between 15 and 60 nm, prepared by cokneading a nickel compound with an alumina gel, followed by a shaping, a drying and a reduction.

Furthermore, for the purpose of obtaining better catalytic performance qualities, in particular a better selectivity and/or activity, it is known in the state of the art to effect the use of additives of organic compounds type in the preparation of metal selective hydrogenation catalysts or metal catalysts for the hydrogenation of aromatics.

For example, Application FR 2 984 761 discloses a process for the preparation of a selective hydrogenation catalyst comprising a support and an active phase comprising a metal from Group VIII, the said catalyst being prepared by a process comprising a stage of impregnation with a solution containing a precursor of the metal from Group VIII and an organic additive, more particularly an organic compound exhibiting from one to three carboxylic acid functional groups, a stage of drying the impregnated support and a stage of calcination of the dried support in order to obtain the catalyst.

The document US2006/0149097 discloses a process for the hydrogenation of aromatic compounds of benzenepolycarboxylic acid type in the presence of a catalyst comprising an active phase comprising at least one metal from Group VIII, which catalyst being prepared by a process comprising a stage of impregnation with a solution containing a precursor of the metal from Group VIII and a stage of impregnation with an organic additive of amine or amino acid type. The stage of impregnation with the organic additive can be carried out before or after the stage of impregnation with the active phase, or even simultaneously.

The Applicant Company has discovered, surprisingly, that a nickel-based catalyst supported on alumina, prepared by cokneading a calcined porous aluminium oxide with a solution comprising at least one nickel precursor and at least one additive of organic compound type chosen from organic compounds comprising at least one carboxylic acid functional group, or at least one alcohol functional group, or at least one ester functional group, or at least one amide functional group, or at least one amine functional group, makes it possible to obtain performance qualities in the selective hydrogenation of polyunsaturated compounds or in the hydrogenation of aromatic compounds, in terms of activity, which are at least as good, indeed even better, than the known processes of the state of the art.

The resulting pore distribution of such a process of preparation by cokneading makes it possible to provide a porosity which is particularly appropriate for promoting the diffusion of the reactants in the porous medium and then their reaction with the active phase. This is because, in addition to the reduction in the number of stages and thus in the manufacturing cost, the advantage of a cokneading, compared to an impregnation, is that any risk of partial blocking of the porosity of the support during the deposition of the active phase and thus the appearance of internal diffusional limitations is significantly reduced.

Furthermore, such a catalyst, used in the context of a process for the selective hydrogenation of polyunsaturated compounds or of a process for the hydrogenation of the aromatic or polyaromatic compounds, exhibits the distinguishing feature of being able to contain high amounts of active phase. This is because the fact of preparing the catalyst according to the invention by cokneading makes it possible to be able to highly charge this catalyst with active phase in a single pass.

It is important to emphasize that the catalyst obtained by the preparation process according to the invention differs structurally from a catalyst obtained by simple impregnation of a metal precursor on the alumina support in which the alumina forms the support and the active phase is introduced into the pores of this support. Without wishing to be committed to any one theory, it appears that the preparation process according to the invention makes it possible to obtain a composite in which the nickel particles and the alumina are intimately mixed, thus forming the actual structure of the catalyst, with a porosity and a content of active phase which are appropriate for the desired reactions.

Subject-Matters of the Invention

A first subject-matter of the present invention is a process for the preparation of a catalyst comprising an oxide matrix having a content of calcined alumina of greater than or equal to 90% by weight, with respect to the total weight of the said matrix, and an active phase comprising nickel, the said active phase not comprising a metal from Group VIb, the content of nickel being between 1% and 65% by weight of the said element, with respect to the total weight of the catalyst, the said active phase being provided in the form of nickel particles having a diameter of less than or equal to 18 nm, the said catalyst comprising a total pore volume, measured by mercury porosimetry, of greater than 0.10 ml/g, a mesopore volume, measured by mercury porosimetry, of greater than 0.10 ml/g, a macropore volume, measured by mercury porosimetry, of less than or equal to 0.6 ml/g, a median mesopore diameter of between 3 and 25 nm, a median macropore diameter of between 50 and 1500 nm, and an SBET specific surface of between 20 and 400 m²/g, which process comprises the following stages:
a) a calcined porous aluminium oxide is prepared;
b) the calcined porous aluminium oxide obtained in stage a) is kneaded with a solution resulting from a mixing of one or more solution(s) comprising at least one nickel precursor and at least one solution comprising at least one organic compound comprising at least one carboxylic acid functional group, or at least one alcohol functional group, or at least one ester functional group, or at least one amine functional group, or at least one amide functional group, in order to obtain a paste, the molar ratio of the said organic compound to the element nickel being between 0.01 and 5.0 mol/mol;
c) the paste obtained in stage b) is shaped;
d) the shaped paste obtained in stage c) is dried at a temperature of less than 250° C. in order to obtain a dried catalyst;
e) optionally, a heat treatment of the dried catalyst obtained in stage d) is carried out at a temperature of between 250 and 1000° C., in the presence or absence of water.

In one embodiment according to the invention, the said organic compound comprises at least one carboxylic acid functional group.

Preferably, the said organic compound is chosen from monocarboxylic acids, dicarboxylic acids, tricarboxylic acids or tetracarboxylic acids.

In one embodiment according to the invention, the said organic compound comprises at least one alcohol functional group.

Preferably, the said organic compound is chosen from:
organic compounds comprising just one alcohol functional group;
organic compounds comprising two alcohol functional groups;
organic compounds chosen from diethylene glycol, triethylene glycol, tetraethylene glycol or a polyethylene glycol corresponding to the formula H(OC₂H₄)ₙOH with n greater than 4 and having an average molar mass of less than 20 000 g/mol;
monosaccharides of empirical formula Cₙ(H₂O)ₚ with n between 3 and 12;
disaccharides, trisaccharides or monosaccharide derivatives.

In one embodiment according to the invention, the said organic compound comprises at least one ester functional group.

Preferably, the said organic compound is chosen from:
carboxylic acid linear or cyclic or unsaturated cyclic esters;
organic compounds comprising at least two carboxylic acid ester functional groups;
organic compounds comprising at least one carboxylic acid ester functional group and at least one second functional group chosen from alcohols, ethers, ketones or aldehydes;
carbonic acid cyclic or linear esters;
carbonic acid linear diesters.

In one embodiment according to the invention, the said organic compound comprises at least one amide functional group.

Preferably, the said organic compound is chosen from:
acyclic amides comprising one or two amide functional groups;
cyclic amides or lactams;
organic compounds comprising at least one amide functional group and a carboxylic acid functional group or an alcohol functional group;
organic compounds comprising at least one amide functional group and an additional nitrogen heteroatom.

In one embodiment according to the invention, the said organic compound comprises at least one amine functional group corresponding to the empirical formula CₓN_{y}H_{z} in which x is between 1 and 20, y=1−x and z=2−(2x+2).

In one embodiment according to the invention, the said calcined porous aluminium oxide according to stage a) is obtained by the following stages:

a1) a first stage of precipitation, in an aqueous reaction medium, of at least one basic precursor chosen from sodium aluminate, potassium aluminate, ammonia, sodium hydroxide and potassium hydroxide and of at least one acidic precursor chosen from aluminium sulfate, aluminium chloride, aluminium nitrate, sulfuric acid, hydrochloric acid and nitric acid, in which at least one of the basic or acidic precursors comprises aluminium, the relative flow rates of the acidic and basic precursors are chosen so as to obtain a pH of the reaction medium of between 8.5 and 10.5 and the flow rates of the acidic and basic precursor or precursors containing aluminium are adjusted so as to obtain a degree of progression of the first stage of between 5% and 13%, the degree of progression being defined as being the proportion of alumina formed as Al₂O₃ equivalent during the said first precipitation stage, with respect to the total amount of alumina formed on conclusion of stage a3) of the preparation process, the said stage being carried out at a temperature of between 20 and 90° C. and for a period of time of between 2 minutes and 30 minutes;

a2) a stage of heating the suspension at a temperature of between 40 and 90° C. for a period of time of between 7 minutes and 45 minutes;

a3) a second stage of precipitation of the suspension obtained on conclusion of the heating stage a2) by addition, to the suspension, of at least one basic precursor chosen from sodium aluminate, potassium aluminate, ammonia, sodium hydroxide and potassium hydroxide and of at least one acidic precursor chosen from aluminium sulfate, aluminium chloride, aluminium nitrate, sulfuric acid, hydrochloric acid and nitric acid, in which at least one of the basic or acidic precursors comprises aluminium, the relative flow rates of the acidic and basic precursors are chosen so as to obtain a pH of the reaction medium of between 8.5 and 10.5 and the flow rates of the acidic and basic precursor or precursors containing aluminium are adjusted so as to obtain a degree of progression of the second stage of between 87% and 95%, the degree of progression being defined as being the proportion of alumina formed as Al₂O₃ equivalent during the said second precipitation stage, with respect to the total amount of alumina formed on conclusion of stage a3) of the preparation process, the said stage being carried out at a temperature of between 40 and 90° C. and for a period of time of between 2 minutes and 50 minutes;

a4) a stage of filtration of the suspension obtained on conclusion of the second precipitation stage a3) in order to obtain an alumina gel;

a5) a stage of drying the said alumina gel obtained in stage a4) in order to obtain a powder;

a6) a stage of heat treatment of the powder obtained on conclusion of stage a5) at between 500 and 1000° C., for a period of time of between 2 and 10 h, in the presence or absence of a stream of air containing up to 60% by volume of water, in order to obtain a calcined porous aluminium oxide.

In one embodiment according to the invention, the said calcined porous aluminium oxide according to stage a) is obtained by the following stages:

a1′) a stage of dissolving an acidic aluminium precursor chosen from aluminium sulfate, aluminium chloride and aluminium nitrate in water, at a temperature of between 20 and 90° C., at a pH of between 0.5 and 5, for a period of time of between 2 and 60 minutes,

a2′) a stage of adjustment of the pH by addition, to the suspension obtained in stage a1′), of at least one basic precursor chosen from sodium aluminate, potassium aluminate, ammonia, sodium hydroxide and potassium hydroxide, at a temperature of between 20 and 90° C. and at a pH of between 7 and 10, for a period of time of between 5 and 30 minutes,

a3′) a stage of coprecipitation of the suspension obtained on conclusion of stage a2′) by addition, to the suspension, of at least one basic precursor chosen from sodium aluminate, potassium aluminate, ammonia, sodium hydroxide and potassium hydroxide and of at least one acidic precursor chosen from aluminium sulfate, aluminium chloride, aluminium nitrate, sulfuric acid, hydrochloric acid and nitric acid, at least one of the basic or acidic precursors comprising aluminium, the relative flow rates of the acidic and basic precursors being chosen so as to obtain a pH of the reaction medium of between 7 and 10 and the flow rates of the acidic and basic precursor or precursors containing aluminium being adjusted so as to obtain a final concentration of alumina in the suspension of between 10 and 38 g/l,

a4′) a stage of filtration of the suspension obtained on conclusion of the coprecipitation stage a3′) in order to obtain an alumina gel,

a5′) a stage of drying the said alumina gel obtained in stage a4′) in order to obtain a powder,

a6′) a stage of heat treatment of the powder obtained on conclusion of stage a5′) at a temperature of between 500 and 1000° C., in the presence or absence of a stream of air containing up to 60% by volume of water, for a period of time of between 2 and 10 hours, in order to obtain a calcined porous aluminium oxide.

In one embodiment according to the invention, the said calcined porous aluminium oxide according to stage a) is obtained by the following stages:

a1″) at least one first stage of precipitation of alumina, in an aqueous reaction medium, from at least one basic precursor chosen from sodium aluminate, potassium aluminate, ammonia, sodium hydroxide and potassium hydroxide and from at least one acidic precursor chosen from aluminium sulfate, aluminium chloride, aluminium nitrate, sulfuric acid, hydrochloric acid and nitric acid, in which at least one of the basic or acidic precursors comprises aluminium, the relative flow rates of the acidic and basic precursors are chosen so as to obtain a pH of the reaction medium of between 8.5 and 10.5 and the flow rates of the acidic and basic precursor or precursors containing aluminium are adjusted so as to obtain a degree of progression of the said first stage of between 40% and 100%, the degree of progression being defined as being the proportion of alumina formed as Al₂O₃ equivalent during the said first precipitation stage, with respect to the total amount of alumina formed on conclusion of stage c) of the preparation process, the said first precipitation stage being carried out at a temperature of between 10 and 50° C. and for a period of time of between 2 minutes and 30 minutes;

a2″) a stage of heat treatment of the suspension heated at a temperature of between 50 and 200° C. for a period of time of between 30 minutes and 5 hours, making it possible to obtain an alumina gel;

a3″) a stage of filtration of the suspension obtained on conclusion of the heat treatment stage a2″), followed by at least one stage of washing the gel obtained;

a4″) a stage of drying the alumina gel obtained on conclusion of stage a3″) in order to obtain a powder;

a5″) a stage of heat treatment of the powder obtained on conclusion of stage a4″) at a temperature of between 500 and 1000° C., in the presence or absence of a stream of air containing up to 60% by volume of water, in order to obtain a calcined porous aluminium oxide.

Another subject-matter according to the invention relates to a process for the selective hydrogenation of polyunsaturated compounds containing at least 2 carbon atoms per molecule, such as diolefins and/or acetylenics and/or alkenylaromatics, present in a hydrocarbon feedstock having a final boiling point of less than or equal to 300° C., which process being carried out at a temperature of between 0 and 300° C., at a pressure of between 0.1 and 10 MPa, at a hydrogen/(polyunsaturated compounds to be hydrogenated) molar ratio of between 0.1 and 10 and at an hourly space velocity of between 0.1 and 200 h⁻¹ when the process is carried out in the liquid phase, or at a hydrogen/(polyunsaturated compounds to be hydrogenated) molar ratio of between 0.5 and 1000 and at an hourly space velocity between 100 and 40 000 h⁻¹ when the process is carried out in the gas phase, in the presence of a catalyst obtained by the preparation process according to the invention.

Another subject-matter according to the invention relates to a process for the hydrogenation of at least one aromatic or polyaromatic compound present in a hydrocarbon feedstock having a final boiling point of less than or equal to 650° C., the said process being carried out in the gas phase or in the liquid phase, at a temperature of between 30 and 350° C., at a pressure of between 0.1 and 20 MPa, at a hydrogen/(aromatic compounds to be hydrogenated) molar ratio between 0.1 and 10 and at an hourly space velocity HSV of between 0.05 and 50 h⁻¹, in the presence of a catalyst obtained by the preparation process according to the invention.

### DETAILED DESCRIPTION OF THE INVENTION

### Definitions

“Macropores” is understood to mean pores, the opening of which is greater than 50 nm.

“Mesopores” is understood to mean pores, the opening of which is between 2 nm and 50 nm, limits included.

“Micropores” is understood to mean pores, the opening of which is less than 2 nm.

Total pore volume of the catalyst or of the support used for the preparation of the catalyst according to the invention is understood to mean the volume measured by intrusion with a mercury porosimeter according to Standard ASTM D4284-83 at a maximum pressure of 4000 bar (400 MPa), using a surface tension of 484 dyne/cm and a contact angle of 140°. The wetting angle was taken equal to 140° by following the recommendations of the work “Techniques de l′ingénieur, traité analyse et caractérisation” [Techniques of the Engineer, Analysis Treatise and Characterization], pages 1050-1055, written by Jean Charpin and Bernard Rasneur.

In order to obtain better accuracy, the value of the total pore volume corresponds to the value of the total pore volume measured by intrusion with a mercury porosimeter measured on the sample minus the value of the total pore volume measured by intrusion with a mercury porosimeter measured on the same sample for a pressure corresponding to 30 psi (approximately 0.2 MPa).

The volume of the macropores and of the mesopores is measured by porosimetry by intrusion of mercury according to Standard ASTM D4284-83 at a maximum pressure of 4000 bar (400 MPa), using a surface tension of 484 dyne/cm and a contact angle of 140°. The value from which the mercury fills all the intergranular voids is set at 0.2 MPa and it is considered that, above this, the mercury penetrates into the pores of the sample.

The macropore volume of the catalyst or of the support used for the preparation of the catalyst according to the invention is defined as being the cumulative volume of mercury introduced at a pressure of between 0.2 MPa and 30 MPa, corresponding to the volume present in the pores with an apparent diameter of greater than 50 nm.

The mesopore volume of the catalyst or of the support used for the preparation of the catalyst according to the invention is defined as being the cumulative volume of mercury introduced at a pressure of between 30 MPa and 400 MPa, corresponding to the volume present in the pores with an apparent diameter of between 2 and 50 nm.

The volume of the micropores is measured by nitrogen porosimetry. The quantitative analysis of the microporosity is carried out starting from the “t” method (method of Lippens-De Boer, 1965), which corresponds to a transform of the starting adsorption isotherm, as described in the work “Adsorption by powders and porous solids. Principles, methodology and applications”, written by F. Rouquérol, J. Rouquérol and K. Sing, Academic Press, 1999.

The median mesopore diameter is also defined as being the diameter such that all the pores, among the combined pores constituting the mesopore volume, with a size of less than this diameter constitute 50% of the total mesopore volume determined by intrusion with a mercury porosimeter.

The median macropore diameter is also defined as being the diameter such that all the pores, among the combined pores constituting the macropore volume, with a size of less than this diameter constitute 50% of the total macropore volume determined by intrusion with a mercury porosimeter.

The specific surface of the catalyst or of the support used for the preparation of the catalyst according to the invention is understood to mean the BET specific surface determined by nitrogen adsorption in accordance with Standard ASTM D 3663-78 drawn up from the Brunauer-Emmett-Teller method described in the journal “The Journal of the American Society”, 60, 309 (1938).

Size of the nickel nanoparticles is understood to mean the mean diameter of the nickel crystallites measured in their oxide forms. The mean diameter of the nickel crystallites in the oxide form is determined by X-ray diffraction, from the width of the diffraction line located at the angle 20=43° (that is to say, according to the crystallographic direction [200]) using the Scherrer relationship. This method, used in X-ray diffraction on polycrystalline samples or powders, which links the full width at half maximum of the diffraction peaks to the size of the particles, is described in detail in the reference: Appl. Cryst. (1978), 11, 102-113, “Scherrer after sixty years: A survey and some new results in the determination of crystallite size”, J. I. Langford and A. J. C. Wilson.

Subsequently, the groups of chemical elements are given according to the CAS classification (CRC Handbook of Chemistry and Physics, published by CRC Press, Editor in Chief D.R. Lide, 81st edition, 2000-2001). For example, Group VIII according to the CAS classification corresponds to the metals of Columns 8, 9 and 10 according to the new IUPAC classification.

Description of the process for the preparation of the catalyst

Generally, the process for the preparation of the catalyst comprises the following stages:
a) a calcined porous aluminium oxide is prepared;
b) the calcined porous aluminium oxide obtained in stage a) is kneaded with a solution resulting from the mixing of one or more solution(s) comprising at least one nickel precursor and at least one solution comprising at least one organic compound comprising at least one carboxylic acid functional group, or at least one alcohol functional group, or at least one ester functional group, or at least one amide functional group, or at least one amine functional group, in order to obtain a paste, the molar ratio of the said organic compound to the element nickel being between 0.01 and 5.0 mol/mol;
c) the paste obtained in stage b) is shaped;
d) the shaped paste obtained in stage c) is dried at a temperature of less than 250° C. in order to obtain a dried catalyst;
e) optionally, a heat treatment of the dried catalyst obtained in stage d) is carried out at a temperature of between 250 and 1000° C., in the presence or absence of water.

Advantageously, the calcined porous aluminium oxide is obtained from a specific alumina gel. The specific pore distribution observed in the catalyst is in particular due to the process of preparation starting from the specific alumina gel.

Stage a) of Preparation of the Calcined Aluminium Oxide

The calcined aluminium oxide can be synthesized by different methods known to a person skilled in the art. For example, a process for obtaining a gel consisting of a precursor of γ-aluminium oxy(hydroxide) (AIO(OH)) type, otherwise known as boehmite, is employed. The alumina gel can, for example, be obtained by precipitation of basic and/or acidic solutions of aluminium salts caused by a change in pH or any other method known to a person skilled in the art. This method is described in particular by the document P. Euzen, P. Raybaud, X. Krokidis, H. Toulhoat, J. L. Le Loarer, J. P. Jolivet and C. Froidefond, Alumina, in “Handbook of Porous Solids”, edited by F. Schüth, K. S. W. Sing and J. Weitkamp, Wiley-VCH, Weinheim, Germany, 2002, pp. 1591-1677.

Particularly preferably, the porous aluminium oxide is prepared from specific alumina gels prepared according to specific methods of preparation as described below.

### Embodiment 1

According to a first alternative form, the calcined porous aluminium oxide used in the context of the process for the preparation of the catalyst according to the invention is obtained by carrying out the following stages:

a1) a first stage of precipitation, in an aqueous reaction medium, of at least one basic precursor chosen from sodium aluminate, potassium aluminate, ammonia, sodium hydroxide and potassium hydroxide and of at least one acidic precursor chosen from aluminium sulfate, aluminium chloride, aluminium nitrate, sulfuric acid, hydrochloric acid and nitric acid, in which at least one of the basic or acidic precursors comprises aluminium, the relative flow rates of the acidic and basic precursors are chosen so as to obtain a pH of the reaction medium of between 8.5 and 10.5 and the flow rates of the acidic and basic precursor or precursors containing aluminium are adjusted so as to obtain a degree of progression of the first stage of between 5% and 13%, the degree of progression being defined as being the proportion of alumina formed as Al₂O₃ equivalent during the said first precipitation stage, with respect to the total amount of alumina formed on conclusion of stage a3) of the preparation process, the said stage being carried out at a temperature of between 20 and 90° C. and for a period of time of between 2 minutes and 30 minutes;

a2) a stage of heating the suspension at a temperature of between 40 and 90° C. for a period of time of between 7 minutes and 45 minutes;

a3) a second stage of precipitation of the suspension obtained on conclusion of the heating stage a2) by addition, to the suspension, of at least one basic precursor chosen from sodium aluminate, potassium aluminate, ammonia, sodium hydroxide and potassium hydroxide and of at least one acidic precursor chosen from aluminium sulfate, aluminium chloride, aluminium nitrate, sulfuric acid, hydrochloric acid and nitric acid, in which at least one of the basic or acidic precursors comprises aluminium, the relative flow rates of the acidic and basic precursors are chosen so as to obtain a pH of the reaction medium of between 8.5 and 10.5 and the flow rates of the acidic and basic precursor or precursors containing aluminium are adjusted so as to obtain a degree of progression of the second stage of between 87% and 95%, the degree of progression being defined as being the proportion of alumina formed as Al₂O₃ equivalent during the said second precipitation stage, with respect to the total amount of alumina formed on conclusion of stage a3) of the preparation process, the said stage being carried out at a temperature of between 40 and 90° C. and for a period of time of between 2 minutes and 50 minutes;

a4) a stage of filtration of the suspension obtained on conclusion of the second precipitation stage a3) in order to obtain an alumina gel;

a5) a stage of drying the said alumina gel obtained in stage a4) in order to obtain a powder; for example at a temperature of between 20 and 200° C. and for a period of time of between 8 h and 15 h;

a6) a stage of heat treatment of the powder obtained on conclusion of stage a5) at between 500 and 1000° C., for a period of time of between 2 and 10 h, in the presence or absence of a stream of air containing up to 60% by volume of water, in order to obtain a calcined porous aluminium oxide.

The degree of progression for each of the precipitation stages is defined as being the proportion of alumina formed as Al₂O₃ equivalent during the said first or second precipitation stage, with respect to the total amount of alumina formed as Al₂O₃ equivalent on conclusion of the two precipitation stages and more generally on conclusion of the stages for preparation of the alumina gel and in particular on conclusion of stage a3) of the preparation process according to the invention.

### Embodiment 2

According to a second alternative form, the calcined porous aluminium oxide used in the context of the process for the preparation of the catalyst according to the invention is obtained by carrying out the following stages:

a1′) a stage of dissolving an acidic aluminium precursor chosen from aluminium sulfate, aluminium chloride and aluminium nitrate in water, at a temperature of between 20 and 90° C., at a pH of between 0.5 and 5, for a period of time of between 2 and 60 minutes,

a2′) a stage of adjustment of the pH by addition, to the suspension obtained in stage a1′), of at least one basic precursor chosen from sodium aluminate, potassium aluminate, ammonia, sodium hydroxide and potassium hydroxide, at a temperature of between 20 and 90° C. and at a pH of between 7 and 10, for a period of time of between 5 and 30 minutes,

a3′) a stage of coprecipitation of the suspension obtained on conclusion of stage a2′) by addition, to the suspension, of at least one basic precursor chosen from sodium aluminate, potassium aluminate, ammonia, sodium hydroxide and potassium hydroxide and of at least one acidic precursor chosen from aluminium sulfate, aluminium chloride, aluminium nitrate, sulfuric acid, hydrochloric acid and nitric acid, at least one of the basic or acidic precursors comprising aluminium, the relative flow rates of the acidic and basic precursors being chosen so as to obtain a pH of the reaction medium of between 7 and 10 and the flow rates of the acidic and basic precursor or precursors containing aluminium being adjusted so as to obtain a final concentration of alumina in the suspension of between 10 and 38 g/l,

a4′) a stage of filtration of the suspension obtained on conclusion of the coprecipitation stage a3′) in order to obtain an alumina gel,

a5′) a stage of drying the said alumina gel obtained in stage a4′) in order to obtain a powder, it being possible for the said drying stage to be carried out at a temperature of between 120 and 300° C., very preferably at a temperature of between 150 and 250° C., for 2 to 16 h;

a6′) a stage of heat treatment of the powder obtained on conclusion of stage a5′) at a temperature of between 500 and 1000° C., in the presence or absence of a stream of air containing up to 60% by volume of water, for a period of time of between 2 and 10 hours, in order to obtain a calcined porous aluminium oxide.

### Embodiment 3

According to a third alternative form, the calcined porous aluminium oxide used in the context of the process for the preparation of the catalyst according to the invention is obtained by carrying out the following stages:

a1″) at least one first stage of precipitation of alumina, in an aqueous reaction medium, from at least one basic precursor chosen from sodium aluminate, potassium aluminate, ammonia, sodium hydroxide and potassium hydroxide and from at least one acidic precursor chosen from aluminium sulfate, aluminium chloride, aluminium nitrate, sulfuric acid, hydrochloric acid and nitric acid, in which at least one of the basic or acidic precursors comprises aluminium, the relative flow rates of the acidic and basic precursors are chosen so as to obtain a pH of the reaction medium of between 8.5 and 10.5 and the flow rates of the acidic and basic precursor or precursors containing aluminium are adjusted so as to obtain a degree of progression of the said first stage of between 40% and 100%, the degree of progression being defined as being the proportion of alumina formed as Al₂O₃ equivalent during the said first precipitation stage, with respect to the total amount of alumina formed on conclusion of stage c) of the preparation process, the said first precipitation stage being carried out at a temperature of between 10 and 50° C. and for a period of time of between 2 minutes and 30 minutes;

a2″) a stage of heat treatment of the suspension heated at a temperature of between 50 and 200° C. for a period of time of between 30 minutes and 5 hours, making it possible to obtain an alumina gel;

a3″) a stage of filtration of the suspension obtained on conclusion of the heat treatment stage a2″), followed by at least one stage of washing the gel obtained;

a4″) a stage of drying the alumina gel obtained on conclusion of stage a3″) in order to obtain a powder; the said drying stage being carried out at a temperature of between 20 and 250° C., preferably between 50 and 200° C., for a period of time of between 1 day and 3 weeks, preferably between 2 hours and 1 week and more preferably still between 5 hours and 48 hours;

a5″) a stage of heat treatment of the powder obtained on conclusion of stage a4″) at a temperature of between 500 and 1000° C., in the presence or absence of a stream of air containing up to 60% by volume of water, for a period of time of between 2 and 10 h, in order to obtain a calcined porous aluminium oxide.

Generally, “degree of progression” of the nth precipitation stage is understood to mean the percentage of alumina formed as Al₂O₃ equivalent in the said nth stage, with respect to the total amount of alumina formed on conclusion of all of the precipitation stages and more generally on conclusion of the stages for preparation of the alumina gel.

In the case where the degree of progression of the said precipitation stage a1″) is 100%, the said precipitation stage a1″) generally makes it possible to obtain an alumina suspension having a concentration of Al₂O₃ of between 20 and 100 g/l, preferably between 20 and 80 g/l, in a preferred way between 20 and 50 g/l.

Stage b) Cokneading

In this stage, the calcined porous aluminium oxide obtained in stage a) is kneaded with a solution resulting from a mixing of one or more solution(s) comprising a nickel precursor and at least one solution comprising at least one organic compound comprising at least one carboxylic acid functional group, or at least one alcohol functional group, or at least one ester functional group, or at least one amide functional group, or at least one amine functional group, in order to obtain a paste, the molar ratio of the said organic compound to the element nickel being between 0.01 and 5.0 mol/mol.

The said solution(s) comprising a nickel precursor can be aqueous or composed of an organic solvent or else of a mixture of water and of at least one organic solvent (for example ethanol or toluene). Preferably, the solution is aqueous. The pH of this solution can be modified by the optional addition of an acid. According to another preferred alternative form, the aqueous solution can contain ammonia or ammonium NH₄_{⁺} ions.

Preferably, the said nickel precursor is introduced in aqueous solution, for example in the nitrate, carbonate, acetate, chloride, hydroxide, hydroxycarbonate or oxalate form, in the form of complexes formed by a polyacid or an acid alcohol and its salts, of complexes formed with acetylacetonates or of any other inorganic derivative soluble in aqueous solution, which is brought into contact with the said calcined porous aluminium oxide. Preferably, use is advantageously made, as nickel precursor, of nickel nitrate, nickel chloride, nickel acetate or nickel hydroxycarbonate. Very preferably, the nickel precursor is nickel nitrate or nickel hydroxycarbonate.

According to another preferred alternative form, the said nickel precursor is introduced in ammoniacal solution by introducing a nickel salt, for example nickel hydroxide or nickel carbonate, into an ammoniacal solution or into a solution of ammonium carbonate or of ammonium hydrogencarbonate.

The amounts of the nickel precursor(s) introduced into the solution are chosen in such a way that the total nickel content is between 1% and 65% by weight, preferably between 5% and 55% by weight, preferably between 8% and 40% by weight and particularly preferably between 10% and 35% by weight, more preferably still between 12% and 35% by weight, more preferably still between 15% and 35% by weight and more particularly preferably between 18% and 32% by weight of the said element, with respect to the total weight of the catalyst. The nickel contents are generally suited to the hydrogenation reactions targeted, as described above.

The said solution(s) containing at least one organic compound comprising at least one carboxylic acid functional group, or at least one alcohol functional group, or at least one ester functional group, or at least one amide functional group, or at least one amine functional group, can be aqueous or organic (for example methanol or ethanol or phenol or acetone or toluene or dimethyl sulf oxide (DMSO)) or else consist of a mixture of water and of at least one organic solvent. The said organic compound(s) is(are) at least partially dissolved beforehand in the said solution(s) at the desired concentration. Preferably, the said solution(s) is(are) aqueous or contain(s) ethanol. More preferably still, the said solution is aqueous. The pH of the said solution can be modified by the optional addition of an acid or of a base.

The cokneading advantageously takes place in a kneader, for example a kneader of “Brabender” type well known to a person skilled in the art. The calcined alumina powder obtained in stage a) is placed in the vessel of the kneader. Subsequently, the solution resulting from the mixing of one or more solution(s) comprising at least one nickel precursor and of at least one solution comprising at least one organic compound comprising at least one carboxylic acid functional group, or at least one alcohol functional group, or at least one ester functional group, or at least one amide functional group, or at least one amine functional group, and optionally of deionized water, is added with a syringe or with any other means over a period of time of a few minutes, typically approximately 2 minutes, at a given kneading rate. After obtaining a paste, the kneading can be continued for a few minutes, for example approximately 15 minutes, at 50 rev/min.

The said solution resulting from the mixing can also be added in several goes during this cokneading phase.

A) Organic Compound Comprising at Least One Carboxylic Acid Functional Group

In one embodiment according to the invention, the organic compound comprises at least one carboxylic acid functional group.

The molar ratio of the said organic compound comprising at least one carboxylic acid functional group is between 0.01 and 5.0 mol/mol, preferably between 0.05 and 2.0 mol/mol, more preferably between 0.1 and 1.5 mol/mol and more preferably still between 0.3 and 1.2 mol/mol, with respect to the element nickel.

The said organic compound comprising at least one carboxylic acid functional group can be a saturated or unsaturated aliphatic organic compound or an aromatic organic compound. Preferably, the saturated or unsaturated aliphatic organic compound comprises between 1 and 9 carbon atoms, preferably between 2 and 7 carbon atoms. Preferably, the aromatic organic compound comprises between 7 and 10 carbon atoms, preferably between 7 and 9 carbon atoms.

The said saturated or unsaturated aliphatic organic compound or the said aromatic organic compound comprising at least one carboxylic acid functional group can be chosen from monocarboxylic acids, dicarboxylic acids, tricarboxylic acids or tetracarboxylic acids. In a specific embodiment of the invention, the said organic compound is a saturated aliphatic monocarboxylic acid, the aliphatic chain being linear or branched or cyclic. When the organic compound is a saturated linear monocarboxylic acid, it is preferably chosen from formic acid, acetic acid, propionic acid, butanoic acid, valeric acid, hexanoic acid, heptanoic acid, octanoic acid or nonanoic acid. When the organic compound is a saturated branched monocarboxylic acid, it is preferably chosen from isobutyric acid, pivalic acid, 4-methyloctanoic acid, 3-methylvaleric acid, 4-methylvaleric acid, 2-methylvaleric acid, isovaleric acid, 2-ethylhexanoic acid, 2-methylbutyric acid, 2-ethylbutyric acid, 2-propylpentanoic acid or valproic acid, in any one of their isomeric forms. When the organic compound is a saturated cyclic monocarboxylic acid, it is preferably chosen from cyclopentanecarboxylic acid or cyclohexanecarboxylic acid. In a specific embodiment of the invention, the said organic compound is an unsaturated aliphatic monocarboxylic acid, the aliphatic chain being linear or branched or cyclic, preferably chosen from methacrylic acid, acrylic acid, vinylacetic acid, crotonic acid, isocrotonic acid, penten-2-oic acid, penten-3-oic acid, penten-4-oic acid, tiglic acid, angelic acid, sorbic acid or acetylenecarboxylic acid, in any one of their isomeric forms.

In a specific embodiment of the invention, the said organic compound is an aromatic monocarboxylic acid preferably chosen from benzoic acid, methylbenzoic acid, dimethylbenzoic acid, trimethylbenzoic acid, ethylbenzoic acid, o-tolylacetic acid, phenylacetic acid, 2-phenylpropionic acid, 3-phenylpropionic acid, 4-vinylbenzoic acid, phenylacetylenecarbonic acid or cinnamic acid, in any one of their isomeric forms.

In a specific embodiment of the invention, the said organic compound is a saturated or unsaturated aliphatic dicarboxylic acid, the aliphatic chain being linear or branched or cyclic. When the organic compound is a saturated linear dicarboxylic acid, it is preferably chosen from ethanedioic acid (oxalic acid), propanedioic acid (malonic acid), butanedioic acid (succinic acid), pentanedioic acid (glutaric acid), hexanedioic acid (adipic acid), heptanedioic acid (pimelic acid), octanedioic acid (suberic acid) or nonanedioic acid (azelaic acid). When the organic compound is a saturated branched dicarboxylic acid, it is preferably chosen from 2-methylglutaric acid, 3-methylglutaric acid, 3,3-dimethylglutaric acid, 2,2-dimethylglutaric acid or butane-1,2-dicarboxylic acid, in any one of their isomeric forms.

When the organic compound is a saturated cyclic dicarboxylic acid, it is preferably chosen from cyclohexanedicarboxylic acid or pinic acid, in any one of their isomeric forms.

Preferably, the said organic compound is chosen from ethanedioic acid (oxalic acid), propanedioic acid (malonic acid), butanedioic acid (succinic acid), pentanedioic acid (glutaric acid), 1,2-cyclohexanedicarboxylic acid or 1,3-cyclohexanedicarboxylic acid, in any one of their isomeric forms. More preferably still, the said organic compound is chosen from ethanedioic acid (oxalic acid), propanedioic acid (malonic acid), butanedioic acid (succinic acid) or pentanedioic acid (glutaric acid).

When the organic compound is an unsaturated, linear or branched or cyclic, dicarboxylic acid, it is preferably chosen from (Z)-butenedioic acid (maleic acid), (E)-butenedioic acid (fumaric acid), pent-2-enedioic acid (glutaconic acid), (2E,4E)-hexa-2,4-dienedioic acid (muconic acid), mesaconic acid, citraconic acid, acetylenedicarboxylic acid, 2-methylenesuccinic acid (itaconic acid) or hexa-2,4-dienedioic acid, in any one of their isomeric forms.

Preferably, the said organic compound is chosen from (Z)-butenedioic acid (maleic acid), (E)-butenedioic acid (fumaric acid), pent-2-enedioic acid (glutaconic acid), mesaconic acid, citraconic acid or 2-methylenesuccinic acid (itaconic acid), in any one of their isomeric forms. More preferably still, the said organic compound is chosen from (Z)-butenedioic acid (maleic acid), (E)-butenedioic acid (fumaric acid) or pent-2-enedioic acid (glutaconic acid).

In a specific embodiment of the invention, the said organic compound is an aromatic dicarboxylic acid preferably chosen from benzene-1,2-dicarboxylic acid (phthalic acid), benzene-1,3-dicarboxylic acid (isophthalic acid), benzene-1,4-dicarboxylic acid (terephthalic acid) or phenylsuccinic acid, in any one of their isomeric forms. Preferably, the said organic compound is benzene-1,2-dicarboxylic acid (phthalic acid).

In a specific embodiment of the invention, the said organic compound is a saturated or unsaturated aliphatic or aromatic tricarboxylic acid preferably chosen from 1,2,3-propanetricarboxylic acid (tricarballylic acid), 1,2,4-butanetricarboxylic acid, 1,2,3-propenetricarboxylic acid (aconitic acid), 1,3,5-benzenetricarboxylic acid (trimesic acid) or 1,2,4-benzenetricarboxylic acid, in any one of their isomeric forms. Preferably, the said organic compound is chosen from 1,2,3-propanetricarboxylic acid (tricarballylic acid), 1,2,4-butanetricarboxylic acid, 1,2,3-propenetricarboxylic acid (aconitic acid) or 1,2,4-benzenetricarboxylic acid, in any one of their isomeric forms.

In a specific embodiment of the invention, the said organic compound is a saturated or unsaturated aliphatic or aromatic tetracarboxylic acid preferably chosen from methanetetracarboxylic acid, 1,2,3,4-butanetetracarboxylic acid, ethylenetetracarboxylic acid or 1,2,4,5-benzenetetracarboxylic acid, in any one of their isomeric forms. Preferably, the said organic compound is chosen from 1,2,3,4-butanetetracarboxylic acid or 1,2,4,5-benzenetetracarboxylic acid, in any one of their isomeric forms.

In another embodiment according to the invention, the said organic compound can comprise at least one second functional group chosen from ethers, hydroxyls, ketones or esters. Advantageously, the said organic compound comprises at least one carboxylic acid functional group and at least one hydroxyl functional group, or at least one carboxylic acid functional group and at least one ether functional group, or at least one carboxylic acid functional group and at least one ketone functional group. Advantageously, the said organic compound can comprise at least three different functional groups chosen from at least one carboxylic acid functional group, at least one hydroxide functional group and at least one functional group other than the carboxylic acid and hydroxyl functional groups, such as an ether functional group or a ketone functional group.

Mention may be made, among organic compounds comprising at least one carboxylic acid functional group and at least one hydroxyl functional group, of hydroxy acids of monocarboxylic acids, hydroxy acids of dicarboxylic acids or of polycarboxylic acids, dihydroxy acids of monocarboxylic acids or of polycarboxylic acids, trihydroxy acids of monocarboxylic acids or of polycarboxylic acids, and more generally polyhydroxy acids of monocarboxylic acids or of polycarboxylic acids, it being possible for the carbon chain of the said acids to be saturated (linear, branched or cyclic) aliphatic or unsaturated (linear, branched or cyclic) aliphatic or to contain at least one aromatic ring. Preferably, the said organic compound is chosen from hydroxy acids or dihydroxy acids of monocarboxylic acids or of dicarboxylic acids or of tricarboxylic acids.

When the organic compound is a hydroxy acid of a monocarboxylic acid, it is preferably chosen from hydroxyacetic acid (glycolic acid), 2-hydroxypropanoic acid (lactic acid), 2-hydroxyisobutyric acid or the other α-hydroxy acids, 3-hydroxypropanoic acid, 3-hydroxybutyric acid, 3-hydroxypentanoic acid, 3-hydroxyisobutyric acid, 3-hydroxy-3-methylbutanoic acid or the other β-hydroxy acids, 4-hydroxybutyric acid or the other γ-hydroxy acids, mandelic acid, 3-phenyllactic acid, tropic acid, hydroxybenzoic acid, salicylic acid, (2-hydroxyphenyl)acetic acid, (3-hydroxyphenyl)acetic acid, (4-hydroxyphenyl)acetic acid or coumaric acid, in any one of their isomeric forms. Preferably, the said organic compound is chosen from hydroxyacetic acid (glycolic acid), 2-hydroxypropanoic acid (lactic acid), 3-hydroxypropanoic acid, 3-hydroxybutyric acid, 3-hydroxyisobutyric acid, mandelic acid, 3-phenyllactic acid, tropic acid or salicylic acid, in any one of their isomeric forms. More preferably still, the said organic compound is chosen from hydroxyacetic acid (glycolic acid), 2-hydroxypropanoic acid (lactic acid), 3-hydroxypropanoic acid, 3-hydroxybutyric acid or 3-hydroxyisobutyric acid.

When the organic compound is a hydroxy acid of a polycarboxylic acid, it is preferably chosen from 2-hydroxypropanedioic acid (tartronic acid), 2-hydroxybutanedioic acid (malic acid), acetolactic acid or the other α-hydroxy acids or β-hydroxy acids or γ-hydroxy acids of dicarboxylic acids, 5-hydroxyisophthalic acid, 2-hydroxypropane-1,2,3-tricarboxylic acid (citric acid), isocitric acid, homocitric acid, homoisocitric acid or the other α-hydroxy acids or β-hydroxy acids or γ-hydroxy acids of tricarboxylic acids, in any one of their isomeric forms. Preferably, the said organic compound is chosen from 2-hydroxypropanedioic acid (tartronic acid), 2-hydroxybutanedioic acid (malic acid), acetolactic acid, 2-hydroxypropane-1,2,3-tricarboxylic acid (citric acid), isocitric acid, homocitric acid or homoisocitric acid, in any one of their isomeric forms. More preferably still, the said organic compound is chosen from 2-hydroxypropanedioic acid (tartronic acid), 2-hydroxybutanedioic acid (malic acid), acetolactic acid or 2-hydroxypropane-1,2,3-tricarboxylic acid (citric acid).

When the organic compound is a dihydroxy acid of a monocarboxylic acid, it is preferably chosen from glyceric acid, 2,3-dihydroxy-3-methylpentanoic acid, pantoic acid or the other α,α-dihydroxy acids or α,β-dihydroxy acids or α,γ-dihydroxy acids, 3,5-dihydroxy-3-methylpentanoic acid (mevalonic acid) or the other β,β-dihydroxy acids or β,γ-dihydroxy acids or γ,γ-dihydroxy acids, bis(hydroxymethyl)-2,2-propionic acid, 2,3-dihydroxybenzoic acid, α-resorcylic acid, β-resorcylic acid, γ-resorcylic acid, gentisic acid, protocatechuic acid, orsellinic acid, homogentisic acid or caffeic acid, in any one of their isomeric forms. Preferably, the said organic compound is chosen from glyceric acid, 2,3-dihydroxy-3-methylpentanoic acid, pantoic acid, 2,3-dihydroxybenzoic acid, β-resorcylic acid, γ-resorcylic acid, gentisic acid or orsellinic acid, in any one of their isomeric forms. More preferably still, the said organic compound is chosen from glyceric acid, 2,3-dihydroxy-3-methylpentanoic acid or pantoic acid.

When the organic compound is a dihydroxy acid of a polycarboxylic acid, it is preferably chosen from dihydroxymalonic acid, 2,3-dihydroxybutanedioic acid (tartaric acid) or the other α,α-dihydroxy acids or α,β-dihydroxy acids or α,γ-dihydroxy acids or β,β-dihydroxy acids or β,γ-dihydroxy acids or γ,γ-dihydroxy acids of dicarboxylic acids, or hydroxycitric acid, in any one of their isomeric forms. Preferably, the said organic compound is chosen from dihydroxymalonic acid, 2,3-dihydroxybutanedioic acid (tartaric acid) or hydroxycitric acid, in any one of their isomeric forms. More preferably still, the said organic compound is chosen from dihydroxymalonic acid or 2,3-dihydroxybutanedioic acid (tartaric acid).

When the organic compound is a polyhydroxy acid of a monocarboxylic acid or of a polycarboxylic acid, it is preferably chosen from shikimic acid, trihydroxybenzoic acid, gallic acid, phloroglucinol carboxylic acid, pyrogallolcarboxylic acid, quinic acid, gluconic acid, mucic acid or saccharic acid, in any one of their isomeric forms. Preferably, the said organic compound is chosen from trihydroxybenzoic acid, quinic acid, gluconic acid, mucic acid or saccharic acid, in any one of their isomeric forms. More preferably still, the said organic compound is chosen from quinic acid, gluconic acid, mucic acid or saccharic acid.

Mention may be made, among the organic compounds comprising at least one carboxylic acid functional group and at least one ether functional group, of 2-methoxyacetic acid, 2,2′-oxydiacetic acid (diglycolic acid), 4-methoxybenzoic acid, 4-isopropoxybenzoic acid, 3-methoxyphenylacetic acid, 3-methoxycinnamic acid, 4-methoxycinnamic acid, 3,4-dimethoxycinnamic acid, veratric acid, tetrahydrofuran-2-carboxylic acid, furan-3-carboxylic acid or 2,5-dihydrofuran-3,4-dicarboxylic acid, according to any one of their isomeric forms. Preferably, the said organic compound is 2,2′-oxydiacetic acid (diglycolic acid).

Mention may be made, among the organic compounds comprising at least one carboxylic acid functional group and at least one ketone functional group, of glyoxylic acid, 2-oxopropanoic acid (pyruvic acid), 2-oxobutanoic acid, 3-oxopentanoic acid, 3-methyl-2-oxobutanoic acid, 4-methyl-2-oxopentanoic acid, phenylglyoxylic acid, phenylpyruvic acid, mesoxalic acid, 2-oxoglutaric acid, 2-oxohexanedioic acid, oxalosuccinic acid or the other α-keto acids of monocarboxylic acids or of polycarboxylic acids, acetylacetic acid, acetonedicarboxylic acid or the other β-keto acids of monocarboxylic acids or of polycarboxylic acids, 4-oxopentanoic acid (levulinic acid) or the other γ-keto acids of monocarboxylic acids or of polycarboxylic acids, 4-acetylbenzoic acid, dioxosuccinic acid, 4-maleylacetoacetic acid or the other polyketo acids of monocarboxylic acids or of polycarboxylic acids, according to any one of their isomeric forms. Preferably, the said organic compound is chosen from glyoxylic acid, 2-oxopropanoic acid (pyruvic acid), 2-oxobutanoic acid, 3-methyl-2-oxobutanoic acid, phenylglyoxylic acid, phenylpyruvic acid, mesoxalic acid, 2-oxoglutaric acid, 2-oxohexanedioic acid, oxalosuccinic acid, acetylacetic acid, acetonedicarboxylic acid, 4-oxopentanoic acid (levulinic acid) or dioxosuccinic acid, according to any one of their isomeric forms. More preferably still, the said organic compound is chosen from glyoxylic acid, 2-oxopropanoic acid (pyruvic acid), 2-oxobutanoic acid, 3-methyl-2-oxobutanoic acid, mesoxalic acid, 2-oxoglutaric acid, acetylacetic acid, acetonedicarboxylic acid, 4-oxopentanoic acid (levulinic acid) or dioxosuccinic acid.

Mention may be made, among the organic compounds comprising at least one carboxylic acid functional group and at least one ester functional group, of acetylsalicylic acid.

Mention may be made, among the organic compounds comprising at least one carboxylic acid functional group, at least one hydroxide functional group and at least one ether functional group, of 4-hydroxy-3-methoxybenzoic acid (vanillic acid), syringic acid, glucuronic acid, galacturonic acid, ferulic acid or sinapinic acid, according to any one of their isomeric forms. Preferably, the said organic compound is chosen from 4-hydroxy-3-methoxybenzoic acid (vanillic acid), glucuronic acid or galacturonic acid, according to any one of their isomeric forms.

Mention may be made, among the organic compounds comprising at least one carboxylic acid functional group, at least one hydroxide functional group and at least one ketone functional group, of hydroxypyruvic acid, acetolactic acid, iduronic acid, ulosonic acid, meconic acid or 4-hydroxyphenylpyruvic acid, according to any one of their isomeric forms. Preferably, the said organic compound is chosen from hydroxypyruvic acid, acetolactic acid, iduronic acid or meconic acid, according to any one of their isomeric forms.

Among all the preceding embodiments, the said organic compound comprising at least one carboxylic acid functional group is preferably chosen from ethanedioic acid (oxalic acid), propanedioic acid (malonic acid), butanedioic acid (succinic acid), pentanedioic acid (glutaric acid), 1,2-cyclohexanedicarboxylic acid, 1,3-cyclohexanedicarboxylic acid, (Z)-butenedioic acid (maleic acid), (E)-butenedioic acid (fumaric acid), pent-2-enedioic acid (glutaconic acid), mesaconic acid, citraconic acid, 2-methylenesuccinic acid (itaconic acid), benzene-1,2-dicarboxylic acid (phthalic acid), 1,2,3-propanetricarboxylic acid (tricarballylic acid), 1,2,4-butanetricarboxylic acid, 1,2,3-propenetricarboxylic acid (aconitic acid), 1,2,4-benzenetricarboxylic acid, 1,2,3,4-butanetetracarboxylic acid, 1,2,4,5-benzenetetracarboxylic acid, hydroxyacetic acid (glycolic acid), 2-hydroxypropanoic acid (lactic acid), 3-hydroxypropanoic acid, 3-hydroxybutyric acid, 3-hydroxyisobutyric acid, mandelic acid, 3-phenyllactic acid, tropic acid, salicylic acid, glyceric acid, 2,3-dihydroxy-3-methylpentanoic acid, pantoic acid, 2,3-dihydroxybenzoic acid, β-resorcylic acid, γ-resorcylic acid, gentisic acid, orsellinic acid, dihydroxymalonic acid, 2,3-dihydroxybutanedioic acid (tartaric acid), hydroxycitric acid, trihydroxybenzoic acid, quinic acid, gluconic acid, mucic acid, saccharic acid, 2,2′-oxydiacetic acid (diglycolic acid), glyoxylic acid, 2-oxopropanoic acid (pyruvic acid), 2-oxobutanoic acid, 3-methyl-2-oxobutanoic acid, phenylglyoxylic acid, phenylpyruvic acid, mesoxalic acid, 2-oxoglutaric acid, 2-oxohexanedioic acid, oxalosuccinic acid, acetylacetic acid, acetonedicarboxylic acid, 4-oxopentanoic acid (levulinic acid), dioxosuccinic acid, 4-hydroxy-3-methoxybenzoic acid (vanillic acid), glucuronic acid, galacturonic acid, hydroxypyruvic acid, acetolactic acid, iduronic acid or meconic acid, according to any one of their isomeric forms.

Among all the preceding embodiments, the said organic compound comprising at least one carboxylic acid functional group is more preferably chosen from ethanedioic acid (oxalic acid), propanedioic acid (malonic acid), butanedioic acid (succinic acid), pentanedioic acid (glutaric acid), (Z)-butenedioic acid (maleic acid), (E)-butenedioic acid (fumaric acid), pent-2-enedioic acid (glutaconic acid), hydroxyacetic acid (glycolic acid), 2-hydroxypropanoic acid (lactic acid), 3-hydroxypropanoic acid, 3-hydroxybutyric acid, 3-hydroxyisobutyric acid, 2-hydroxypropanedioic acid (tartronic acid), 2-hydroxybutanedioic acid (malic acid), acetolactic acid, 2-hydroxypropane-1,2,3-tricarboxylic acid (citric acid), glyceric acid, 2,3-dihydroxy-3-methylpentanoic acid, pantoic acid, dihydroxymalonic acid, 2,3-dihydroxybutanedioic acid (tartaric acid), quinic acid, gluconic acid, mucic acid, saccharic acid, glyoxylic acid, 2-oxopropanoic acid (pyruvic acid), 2-oxobutanoic acid, 3-methyl-2-oxobutanoic acid, mesoxalic acid, 2-oxoglutaric acid, acetylacetic acid, acetonedicarboxylic acid, 4-oxopentanoic acid (levulinic acid) or dioxosuccinic acid. More preferably still, the organic compound comprising at least one carboxylic acid functional group is chosen from ethanedioic acid (oxalic acid), propanedioic acid (malonic acid), pentanedioic acid (glutaric acid), hydroxyacetic acid (glycolic acid), 2-hydroxypropanoic acid (lactic acid), 2-hydroxypropanedioic acid (tartronic acid), 2-hydroxypropane-1,2,3-tricarboxylic acid (citric acid), 2,3-dihydroxybutanedioic acid (tartaric acid), 2-oxopropanoic acid (pyruvic acid) or 4-oxopentanoic acid (levulinic acid).

B) Organic Compound Comprising at Least One Alcohol Functional Group

In another embodiment according to the invention, the organic compound comprises at least one alcohol functional group. The molar ratio of the said compound comprising at least one alcohol functional group with respect to the element nickel is between 0.01 and 5.0 mol/mol, preferably between 0.05 and 1.5 mol/mol and more preferably between 0.08 and 0.9 mol/mol.

Preferably, the said organic compound comprises between 2 and 20 carbon atoms, preferably between 2 and 12 carbon atoms and more preferably still between 2 and 8 carbon atoms.

In one embodiment according to the invention, the organic compound comprises just one alcohol functional group (monoalcohol). Preferably, the organic compound is chosen from methanol, ethanol, propanol, butanol, pentanol, hexanol, 2-propyn-1-ol, geraniol, menthol, phenol or cresol, in any one of their isomeric forms. More preferably, the said organic compound is chosen from methanol, ethanol or phenol.

In another embodiment according to the invention, the organic compound comprises at least two alcohol functional groups (diol or more generally polyol). Preferably, the organic compound is selected from ethylene glycol, propane-1,3-diol, butane-1,4-diol, pentane-1,5-diol, hexane-1,6-diol, heptane-1,7-diol, octane-1,8-diol, propane-1,2-diol, butane-1,2-diol, butane-2,3-diol, butane-1,3-diol, pentane-1,2-diol, pentane-1,3-diol, pentane-2,3-diol, pentane-2,4-diol, 2-ethylhexane-1,3-diol (etohexadiol), p-menthane-3,8-diol, 2-methylpentane-2,4-diol, but-2-yne-1,4-diol, 2,3,4-trihydroxypentane, 2,2-dihydroxyhexane, 2,2,4-trihydroxyhexane, glycerol, erythritol, threitol, arabitol, xylitol, ribitol, mannitol, sorbitol, dulcitol, allitol, gluciotol, tolitol, fucitol, iditol, volemitol or inositol, in any one of their isomeric forms. More preferably, the said organic compound is chosen from ethylene glycol, propane-1,3-diol, butane-1,4-diol, pentane-1,5-diol, hexane-1,6-diol, glycerol, xylitol, mannitol or sorbitol, in any one of their isomeric forms.

In another embodiment according to the invention, the organic compound is an aromatic organic compound comprising at least two alcohol functional groups. Preferably, the organic compound is selected from pyrocatechol, resorcinol, hydroquinone, pyrogallol, phloroglucinol, hydroxyquinol, tetrahydroxybenzene or benzenehexol, in any one of their isomeric forms. More preferably, the said organic compound is chosen from pyrocatechol, resorcinol or hydroquinone.

In another embodiment according to the invention, the organic compound can be selected from diethylene glycol, triethylene glycol, tetraethylene glycol or more generally polyethylene glycols corresponding to the formula H(OC₂H₄)ₙOH with n greater than 4 and having an average molar mass of less than 20 000 g/mol. More preferably, the said organic compound is chosen from diethylene glycol, triethylene glycol or polyethylene glycols having an average molar mass of less than 600 g/mol.

In another embodiment according to the invention, the organic compound is a monosaccharide of empirical formula Cₙ(H₂O)ₚ with n between 3 and 12, preferably between 3 and 10. Preferably, the organic compound is selected from glyceraldehyde, dihydroxyacetone, erythrose, threose, erythrulose, lyxose, arabinose, xylose, ribose, ribulose, xylulose, glucose, mannose, sorbose, galactose, fructose, allose, altrose, gulose, idose, talose, psicose, tagatose, sedoheptulose or mannoheptulose, in any one of their isomeric forms. More preferably, the said organic compound is chosen from glucose, mannose or fructose, in any one of their isomeric forms.

In another embodiment according to the invention, the organic compound is a disaccharide or a trisaccharide, or a derivative of a monosaccharide, selected from sucrose, maltose, lactose, cellobiose, gentiobiose, inulobiose, isomaltose, isomaltulose, kojibiose, lactulose, laminaribiose, leucrose, maltulose, melibiose, nigerose, robinoserutinose, sophorose-trehalose, trehalulose, turanose, erlose, fucosyllactose, gentianose, inulotriose, kestose, maltotriose, mannotriose, melezitose, neokestose, panose, raffinose, rhamninose, maltitol, lactitol, isomaltitol or isomaltulose, in any one of their isomeric forms. More preferably, the said organic compound is chosen from sucrose, maltose or lactose, in any one of their isomeric forms.

In another embodiment according to the invention, the organic compound comprises at least one alcohol functional group, at least one ketone functional group and at least unsaturated heterocyclic preferably chosen from isomaltol, maltol, ethyl maltol, dehydroacetic acid, kojic acid or erythorbic acid, in any one of their isomeric forms.

Among all the preceding embodiments, the said organic compound comprising at least one alcohol functional group is preferably chosen from methanol, ethanol, propanol, butanol, pentanol, hexanol, 2-propyn-1-ol, geraniol, menthol, phenol, cresol, ethylene glycol, propane-1,3-diol, butane-1,4-diol, pentane-1,5-diol, hexane-1,6-diol, heptane-1,7-diol, octane-1,8-diol, propane-1,2-diol, butane-1,2-diol, butane-2,3-diol, butane-1,3-diol, pentane-1,2-diol, pentane-1,3-diol, pentane-2,3-diol, pentane-2,4-diol, 2-ethylhexane-1,3-diol, p-menthane-3,8-diol, 2-methylpentane-2,4-diol, but-2-yne-1,4-diol, 2,3,4-trihydroxypentane, 2,2-dihydroxyhexane, 2,2,4-trihydroxyhexane, glycerol, erythritol, threitol, arabitol, xylitol, ribitol, mannitol, sorbitol, dulcitol, allitol, gluciotol, tolitol, fucitol, iditol, volemitol, inositol, pyrocatechol, resorcinol, hydroquinone, pyrogallol, phloroglucinol, hydroxyquinonel, tetrahydroxybenzene, benzenehexol, diethylene glycol, triethylene glycol, tetraethylene glycol, polyethylene glycols corresponding to the formula H(OC₂H₄)ₙOH with n greater than 4 and having an average molar mass of less than 20 000 g/mol, glyceraldehyde, dihydroxyacetone, erythrose, threose, erythrulose, lyxose, arabinose, xylose, ribose, ribulose, xylulose, glucose, mannose, sorbose, galactose, fructose, allose, altrose, gulose, idose, talose, psicose, tagatose, sedoheptulose, mannoheptulose, sucrose, maltose, lactose, cellobiose, gentiobiose, inulobiose, isomaltose, isomaltulose, kojibiose, lactulose, laminaribiose, leucrose, maltulose, melibiose, nigerose, robinoserutinose, sophorose, trehalose, trehalulose, turanose, erlose, fucosyllactose, gentianose, inulotriose, kestose, maltotriose, mannotriose, melezitose, neokestose, panose, raffinose, rhamninose, maltitol, lactitol, isomaltitol, isomaltulose, isomaltol, maltol, ethyl maltol, dehydroacetic acid, kojic acid or erythorbic acid, in any one of their isomeric forms.

More preferably, the said organic compound is chosen from methanol, ethanol, phenol, ethylene glycol, propane-1,3-diol, butane-1,4-diol, pentane-1,5-diol, hexane-1,6-diol, glycerol, xylitol, mannitol, sorbitol, pyrocatechol, resorcinol, hydroquinone, diethylene glycol, triethylene glycol, polyethylene glycols having an average molar mass of less than 600 g/mol, glucose, mannose, fructose, sucrose, maltose or lactose, in any one of their isomeric forms.

C) Organic Compound Comprising at Least One Ester Functional Group

In another embodiment according to the invention, the organic compound comprises at least one ester functional group. The molar ratio of the said organic compound comprising at least one ester functional group with respect to the element nickel is between 0.01 and 5.0 mol/mol, preferably between 0.05 and 2.0 mol/mol, more preferably between 0.1 and 1.5 mol/mol and more preferably still between 0.3 and 1.2 mol/mol.

Preferably, the said organic compound comprises between 2 and 20 carbon atoms, preferably between 3 and 14 carbon atoms and more preferably still between 3 and 8 carbon atoms.

According to the invention, the said organic compound comprises at least one ester functional group. It can be chosen from a linear or cyclic or unsaturated cyclic carboxylic acid ester, or a cyclic or linear carbonic acid ester, or also a linear carbonic acid diester.

In the case of a carboxylic acid cyclic ester, the compound can be a saturated cyclic ester. The term used is α-lactone, β-lactone, γ-lactone, δ-lactone or ε-lactone, according to the number of carbon atoms in the heterocycle. The said compound can also be substituted by one or more alkyl group(s) or aryl group(s) or alkyl group(s) containing unsaturations. Preferably, the said compound is a lactone containing between 4 and 12 carbon atoms, such as γ-butyrolactone, γ-valerolactone, δ-valerolactone, γ-caprolactone, δ-caprolactone, ε-caprolactone, γ-heptalactone, δ-heptalactone, γ-octalactone, O-octalactone, δ-nonalactone, ε-nonlactone, δ-decalactone, γ-decalactone, ε-decalactone, δ-dodecalactone or γ-dodecalactone, in any one of their isomeric forms. More preferably still, the said compound is a γ-lactone or a δ-lactone containing between 4 and 8 carbon atoms, γ-butyrolactone, γ-valerolactone, δ-valerolactone, γ-caprolactone, δ-caprolactone, γ-heptalactone, ε-heptalactone, γ-octalactone or δ-octalactone, in any one of their isomeric forms. Preferably, the compound is γ-valerolactone.

In the case of a carboxylic acid unsaturated cyclic ester (containing unsaturations in the ring), the compound can be furan or pyrone or any one of their derivatives, such as 6-pentyl-α-pyrone.

In the case of a carboxylic acid linear ester, the compound can be a compound comprising just one ester functional group corresponding to the empirical formula RCOOR′, in which R and R′ are linear, branched or cyclic alkyl groups, or alkyl groups containing unsaturations, or alkyl groups substituted by one or more aromatic rings, or aryl groups, each containing between 1 and 15 carbon atoms and being able to be identical or different. The R group can also be the hydrogen atom H. Preferably, the R′ group (of the alkoxy functional group COR′) contains a number of carbon atoms which is less than or equal to that of the R group, more preferably still the number of carbon atoms of the said R′ group is between 1 and 6, more preferably still between 1 and 4. The said organic compound is preferably chosen from methyl methanoate, methyl acetate, methyl propanoate, methyl butanoate, methyl pentanoate, methyl hexanoate, methyl octanoate, methyl decanoate, methyl laurate, methyl dodecanoate, ethyl acetate, ethyl propanoate, ethyl butanoate, ethyl pentanoate or ethyl hexanoate. Preferably, the organic compound is methyl laurate.

In another embodiment according to the invention, the organic compound can be a compound comprising at least two carboxylic acid ester functional groups.

Advantageously, the carbon chain in which these carboxylic acid ester functional groups are inserted is a linear or branched or cyclic aliphatic carbon chain which is saturated or which can contain unsaturations, and contains between 2 and 15 carbon atoms, and each R′ group (of each of the alkoxy functional groups COR′) can be a linear, branched or cyclic alkyl group, or an alkyl group containing unsaturations, or an alkyl group substituted by one or more aromatic rings, or an aryl group, containing between 1 and 15 carbon atoms, preferably between 1 and 6 carbon atoms, more preferably still between 1 and 4 carbon atoms. The different R′ groups can be identical or different. Preferably, the said compound is chosen from dimethyl oxalate, dimethyl malonate, dimethyl succinate, dimethyl glutarate, dimethyl adipate, diethyl oxalate, diethyl malonate, diethyl succinate, diethyl glutarate, diethyl adipate, dimethyl methylsuccinate or dimethyl 3-methylglutarate, in any one of their isomeric form. More preferably, the compound is dimethyl succinate.

In another embodiment according to the invention, the organic compound can be a compound comprising at least one carboxylic acid ester functional group and at least one second functional group chosen from alcohols, ethers, ketones or aldehydes.

Advantageously, the said organic compound comprises at least one carboxylic acid ester functional group and at least one alcohol functional group.

Preferably, the carbon chain in which the carboxylic acid ester functional group(s) is(are) inserted is a linear or branched or cyclic aliphatic carbon chain which is saturated or which can contain unsaturations, and contains between 2 and 15 carbon atoms, and each R′ group (of each of the alkoxy functional groups COR′) can be a linear, branched or cyclic alkyl group, or an alkyl group containing unsaturations, or an alkyl group substituted by one or more aromatic rings, or an aryl group, containing between 1 and 15 carbon atoms, preferably between 1 and 6 carbon atoms, more preferably still between 1 and 4 carbon atoms, it being possible for the different R′ groups to be identical or different. This carbon chain contains at least one hydroxyl group, preferably between 1 and 6 hydroxyl groups.

Preferably, the said compound is chosen from methyl glycolate, ethyl glycolate, butyl glycolate, benzyl glycolate, methyl lactate, ethyl lactate, butyl lactate, tert-butyl lactate, ethyl 3-hydroxybutyrate, ethyl mandelate, dimethyl malate, diethyl malate, diisopropyl malate, dimethyl tartrate, diethyl tartrate, diisopropyl tartrate, trimethyl citrate or triethyl citrate, in any one of their isomeric form. More preferably, the said compound is dimethyl malate.

Advantageously, the said organic compound comprises at least one carboxylic acid ester functional group and at least one ketone or aldehyde functional group. Preferably, the carbon chain in which the carboxylic acid ester functional group(s) is(are) inserted is a linear or branched or cyclic aliphatic carbon chain which is saturated or which can contain unsaturations, and contains between 2 and 15 carbon atoms, and each R′ group (of each of the alkoxy functional groups COR′) can be a linear, branched or cyclic alkyl group, or an alkyl group containing unsaturations, or an alkyl group substituted by one or more aromatic rings, or an aryl group, containing between 1 and 15 carbon atoms, preferably between 1 and 6 carbon atoms, more preferably still between 1 and 4 carbon atoms, it being possible for the different R′ groups to be identical or different. This carbon chain contains at least one ketone or aldehyde functional group, preferably between 1 and 3 ketone or aldehyde functional group(s). Preferably, the organic compound is an aceto acid.

In the case of a carbonic acid cyclic ester, the compound can be ethylene carbonate, propylene carbonate or trimethylene carbonate. Preferably, the compound is propylene carbonate.

In the case of a carbonic acid linear ester, the compound can be dimethyl carbonate, diethyl carbonate or diphenyl carbonate.

In the case of a carbonic acid linear diester, the compound can be dimethyl dicarbonate, diethyl dicarbonate or di(tert-butyl) dicarbonate.

Advantageously, the said organic compound can comprise at least three different functional groups chosen from at least one ester functional group, at least one carboxylic acid functional group and at least one functional group other than the ester and carboxylic acid functional groups, such as an ether functional group or a ketone functional group.

Among all the preceding embodiments, the said organic compound comprising at least one ester functional group is preferably chosen from a γ-lactone or a δ-lactone containing between 4 and 8 carbon atoms, γ-butyrolactone, γ-valerolactone, δ-valerolactone, γ-caprolactone, ε-caprolactone, γ-heptalactone, δ-heptalactone, γ-octalactone, O-octalactone, methyl methanoate, methyl acetate, methyl propanoate, methyl butanoate, methyle pentanoate, methyl hexanoate, methyl octanoate, methyl decanoate, methyl laurate, methyl dodecanoate, ethyl acetate, ethyl propanoate, ethyl butanoate, ethyl pentanoate, ethyl hexanoate, dimethyl oxalate, dimethyl malonate, dimethyl succinate, dimethyl glutarate, dimethyl adipate, diethyl oxalate, diethyl malonate, diethyl succinate, diethyl glutarate, diethyl adipate, dimethyl methylsuccinate, dimethyl 3-methylglutarate, methyl glycolate, ethyl glycolate, butyl glycolate, benzyl glycolate, methyl lactate, ethyl lactate, butyl lactate, tert-butyl lactate, ethyl 3-hydroxybutyrate, ethyl mandelate, dimethyl malate, diethyl malate, diisopropyl malate, dimethyl tartrate, diethyl tartrate, diisopropyl tartrate, trimethyl citrate, triethyl citrate, ethylene carbonate, propylene carbonate, trimethylene carbonate, diethyl carbonate, diphenyl carbonate, dimethyl dicarbonate, diethyl dicarbonate or di(tert-butyl) dicarbonate, in any one of their isomeric form.

D) Organic Compound Comprising at Least One Amide Functional Group

In another embodiment according to the invention, the organic compound comprises at least one amide functional group chosen from an acyclic amide functional group or a cyclic amide functional group optionally comprising alkyl substituents, aryl substituents or alkyl substituents containing unsaturations. The amide functional groups can be chosen from primary, secondary or tertiary amides.

The molar ratio of the said organic compound comprising at least one amide functional group with respect to the element nickel is between 0.01 and 1.5 mol/mol, preferably between 0.05 and 1.0 mol/mol and more preferably between 0.08 and 0.9 mol/mol.

According to a first alternative form, the organic compound comprises at least one acyclic amide functional group.

The said organic compound can comprise just one amide functional group and does not contain another functional group, such as formamide, N-methylformamide, N,N-dimethylformamide, N-ethylformamide, N,N-diethylformamide, N,N-dibutylformamide, N,N-diisopropylformamide, N,N-diphenylformamide, acetamide, N-methylacetamide, N, N-dimethylmethanamide, N,N-diethylacetamide, N,N-dimethylpropionamide, propanamide, N-ethyl-N-methylpropanamide, benzamide or acetanilide, according to any one of their isomeric forms. Preferably, the said organic compound is chosen from formamide, N-methylformamide, N,N-dimethylformamide, N-ethylformamide, N,N-diethylformamide, acetamide, N-methylacetamide, N,N-dimethylmethanamide, N,N-diethylacetamide, N,N-dim ethylpropionam ide or propanamide.

The said organic compound can comprise two amide functional groups and does not contain another functional group, such as tetraacetylethylenediamine.

According to a second alternative form, the organic compound comprises at least one cyclic amide functional group, such as 1-formylpyrrolidine or 1-formylpiperidine, or a lactam functional group. Preferably, the said organic compound is chosen from β-lactam, γ-lactam, δ-lactam and ε-lactam and their derivatives, according to any one of their isomeric forms. More preferably, the said organic compound is chosen from 2-pyrrolidone, N-methyl-2-pyrrolidone, γ-lactam or caprolactam, according to any one of their isomeric forms.

According to a third alternative form, the said organic compound can comprise at least one amide functional group and at least one other functional group other than the amide functional group. Preferably, the said organic compound comprises at least one amide functional group and at least one carboxylic acid functional group, such as acetylleucine, N-acetylaspartic acid, aminohippuric acid, N-acetylglutamic acid or 4-acetamidobenzoic acid, according to any one of their isomeric forms.

Preferably, the said organic compound comprises at least one amide functional group and at least one alcohol functional group, such as glycolamide, lactamide, N,N-diethyl-2-hydroxyacetamide, 2-hydroxy-N-methylacetamide, 3-hydroxypropionamide, mandelamide, acetohydroxamic acid, butyrylhydroxamic acid or bucetin, according to any one of their isomeric forms. Preferably, the said organic compound is chosen from lactamide and glycolamide.

According to a fourth alternative form, the organic compound comprises at least one amide functional group and at least one additional nitrogen heteroatom, preferably chosen from urea, N-methylurea, N,N′-dimethylurea, 1,1-dimethylurea or tetramethylurea, according to any one of their isomeric forms.

Among all the organic compounds comprising at least one amide functional group above, preference is more particularly given to formamide, N-methylformamide, N,N-dimethylformamide, N-ethylformamide, N,N-diethylformamide, acetamide, N-methylacetamide, N,N-dimethylmethanamide, N,N-diethylacetamide, N, N-dimethylpropionamide, propanamide, 2-pyrrolidone, N-methyl-2-pyrrolidone, γ-lactam, caprolactam, acetylleucine, N-acetylaspartic acid, aminohippuric acid, N-acetylglutamic acid, 4-acetamidobenzoic acid, lactamide and glycolamide, urea, N-methylurea, N,N′-dimethylurea, 1,1-dimethylurea or tetramethylurea, according to any one of their isomeric forms.

E) Organic compound comprising at least one amine functional group

In another embodiment according to the invention, the organic compound comprises at least one amine functional group. The molar ratio of the said organic compound comprising at least one amine functional group with respect to the element nickel is between 0.01 and 1.5 mol/mol, preferably between 0.05 and 1.0 mol/mol and more preferably between 0.08 and 0.9 mol/mol.

The said organic compound comprises between 1 and 20 carbon atoms, preferably between 1 and 14 carbon atoms and more preferably still between 2 and 8 carbon atoms.

In one embodiment according to the invention, the organic compound comprises at least one amine functional group corresponding to the empirical formula CₓN_{y}H_{z} in which x is between 1 and 20, y=1−x and z=2−(2x+2). The said organic compound can be chosen from a saturated or unsaturated and aliphatic, cyclic, alicyclic, aromatic or heterocyclic amine optionally comprising alkyl substituents, aryl substituents or alkyl substituents containing unsaturations. The amine functional groups can be chosen from primary, secondary or tertiary amines.

According to a first alternative form, the organic compound comprises just one amine functional group and does not contain another functional group.

More particularly, the said organic compound comprising just one amine functional group is chosen from aliphatic compounds, such as propylamine, ethylmethylamine, butylamine, dimethylisopropylamine, dipropylamine, diisopropylamine or octylamine, cyclic or alicyclic compounds, such as cyclobutylamine or cyclohexylamine, aromatic compounds, such as aniline, N,N-dimethylaniline or xylidines, saturated heterocyclic compounds, such as piperidine, pyrrolidine or morpholine, or unsaturated heterocyclic compounds, such as pyrrole, pyridine, indole or quinoline, it being possible for the said compounds to be substituted by one or more alkyl group(s), aryl group(s) or alkyl group(s) containing unsaturations.

According to a second alternative form, the organic compound comprises two amine functional groups and does not contain another functional group.

More particularly, the said organic compound comprising two amine functional groups is chosen from aliphatic compounds, such as ethylenediamine, 1,3-diaminopropane, 1,2-diaminopropane, diaminohexane, tetramethylenediamine, hexamethylenediamine, tetramethylethylenediamine, tetraethylethylenediamine, benzathine, xylylenediamines or diphenylethylenediamine, cyclic or alicyclic compounds, such as 1,2-diaminocyclohexane, aromatic compounds, such as phenylenediamines and their derivatives, 4,4′-diaminobiphenyl or 1,8-diaminonaphthalene, or heterocyclic compounds, such as piperazine, imidazole, pyrimidine or purine, it being possible for the said compounds to be substituted by one or more alkyl group(s), aryl group(s) or alkyl group(s) containing unsaturations. Preferably, the said organic compound is chosen from ethylenediamine, diaminohexane, tetramethylenediamine, hexamethylenediamine, tetramethylethylenediamine or tetraethylethylenediamine.

According to a third alternative form, the organic compound comprises at least three amine functional groups and does not contain another functional group. More particularly, the said compound is chosen from diethylenetriamine or triethylenetetramine.

Preference is more particularly given, among all the organic compounds comprising at least one amine functional group corresponding to the empirical formula CₓN_{y}H_{z} in which 1≤x≤20, 1≤y≤x, 2≤z≤2x+2 which are mentioned above, to ethylenediamine, diaminohexane, tetramethylenediamine, hexamethylenediamine, tetramethylethylenediamine, tetraethylethylenediamine, diethylenetriamine or triethylenetetramine.

In one embodiment according to the invention, the said organic compound comprises at least one amine functional group and at least one carboxylic acid functional group (amino acid). Among the amino acids, the said organic compound can be chosen from the following compounds: alanine, arginine, asparagine, pyroglutamic acid, citrulline, gabapentin, glutamine, histidine, isoleucine, isoglutamine, leucine, lysine, norvaline, ornithine, phenylalanine, proline, saccharopine, sarcosine, serine, threonine, tryptophan, tyrosine, valine, pyrrolysine, 2-aminoisobutyric acid or ethylenediaminetetraacetic acid (EDTA), according to any one of their isomeric forms. When the compound is an amino acid, it is preferably chosen from alanine, arginine, lysine, proline, serine, threonine or EDTA.

Stage c) Shaping

The paste obtained on conclusion of the cokneading stage b) is subsequently shaped according to any technique known to a person skilled in the art, for example the methods for shaping by extrusion, by pelleting, by the method of the oil drop (draining) or by granulation on a rotating plate.

Preferably, the paste is shaped by extrusion in the form of extrudates with a diameter generally of between 0.5 and 10 mm, preferably 0.8 and 3.2 mm, and very preferably between 1.0 and 2.5 mm. This can advantageously be presented in the form of cylindrical, trilobal or quadrilobal extrudates. Preferably, its shape will be trilobal or quadrilobal.

Very preferably, the said cokneading stage b) and the said shaping stage c) are combined in a single kneading/extrusion stage. In this case, the paste obtained on conclusion of the kneading can be introduced into a piston extruder through a die having the desired diameter, typically between 0.5 and 10 mm.

Stage d) Drying of the Shaped Paste

In accordance with the invention, the shaped paste is subjected to drying d) at a temperature of less than 250° C., preferably of between 15 and 240° C., more preferably between 30 and 220° C., more preferably still between 50 and 200° C. and in an even more preferred way between 70 and 180° C., for a period of time typically of between 10 minutes and 24 hours. Longer periods of time are not ruled out but do not necessarily contribute an improvement. The drying stage can be carried out by any technique known to a person skilled in the art. It is advantageously carried out under an inert atmosphere or under an atmosphere containing oxygen or under a mixture of inert gas and oxygen. It is advantageously carried out at atmospheric pressure or at reduced pressure. Preferably, this stage is carried out at atmospheric pressure and in the presence of air or nitrogen.

Stage e) Heat Treatment of the Dried Catalyst (Optional)

The catalyst thus dried can subsequently be subjected to an additional stage of heat or hydrothermal treatment e) at a temperature of between 250 and 1000° C. and preferably between 250 and 750° C., for a period of time typically of between 15 minutes and 10 hours, under an inert atmosphere or under an atmosphere containing oxygen, in the presence or absence of water. Longer treatment times are not ruled out but do not necessary contribute an improvement. Several combined cycles of heat or hydrothermal treatments can be carried out. After this or these treatment(s), the catalyst precursor comprises nickel in the oxide form, that is to say in the NiO form.

In the case where water is added, contact with the steam can take place at atmospheric pressure or under autogenous pressure. The water content is preferably between 150 and 900 grams per kilogram of dry air and more preferably still between 250 and 650 grams per kilogram of dry air.

Stage f) Reduction by a Reducing Gas (Optional)

Prior to the use of the catalyst in the catalytic reactor and the implementation of a hydrogenation process, at least one reducing treatment stage f) is advantageously carried out in the presence of a reducing gas after stages d) or e), so as to obtain a catalyst comprising nickel at least partially in the metallic form.

This treatment makes it possible to activate the said catalyst and to form metallic particles, in particular of nickel in the zero-valent state. The said reducing treatment can be carried out in situ or ex situ, that is to say after or before the catalyst is charged to the hydrogenation reactor.

The reducing gas is preferably hydrogen. The hydrogen can be used pure or as a mixture (for example a hydrogen/nitrogen, hydrogen/argon or hydrogen/methane mixture). In the case where the hydrogen is used as a mixture, all the proportions can be envisaged.

The said reducing treatment is carried out at a temperature of between 120 and 500° C., preferably between 150 and 450° C. When the catalyst is not subjected to passivation or is subjected to a reducing treatment before passivation, the reducing treatment is carried out at a temperature of between 350 and 500° C., preferably between 350 and 450° C. When the catalyst has been subjected beforehand to a passivation, the reducing treatment is generally carried out at a temperature of between 120 and 350° C., preferably between 150 and 350° C. The duration of the reducing treatment is generally between 2 and 40 hours, preferably between 3 and 30 hours. The rise in temperature up to the desired reduction temperature is generally slow, for example set between 0.1 and 10° C./min, preferably between 0.3 and 7° C./min.

The hydrogen flow rate, expressed in I/hour/gram of catalyst, is between 0.1 and 100 I/hour/gram of catalyst, preferably between 0.5 and 10 I/hour/gram of catalyst and more preferably still between 0.7 and 5 I/hour/gram of catalyst.

Stage q) Passivation (Optional)

Prior to the use thereof in the catalytic reactor, the catalyst according to the invention can optionally be subjected to a stage of passivation (stage g) by a sulfur or oxygen compound or by CO₂, before or after the reducing treatment stage f). This passivation stage can be carried out ex situ or in situ. The passivation stage is carried out by the use of methods known to a person skilled in the art.

The stage of passivation by sulfur makes it possible to improve the selectivity of the catalysts and to prevent thermal runaways during the start-ups of fresh catalysts. The passivation generally consists in irreversibly poisoning, by the sulfur compound, the most virulent active sites of the nickel which exist on the fresh catalyst and thus in weakening the activity of the catalyst in favour of its selectivity. The passivation stage is carried out by the use of methods known to a person skilled in the art and in particular, by way of example, by the use of one of the methods described in the patent documents EP 0 466 567, U.S. Pat. No. 5,153,163, FR 2 676 184, WO2004/098774 and EP 0 707 890. The sulfur compound is, for example, chosen from the following compounds: thiophene, thiophane, alkyl monosulfides, such as dimethyl sulfide, diethyl sulfide, dipropyl sulfide and propyl methyl sulfide, or also an organic disulfide of formula HO—R₁—S—S—R₂—OH, such as dithiodiethanol of formula HO—C₂H₄—S—S—C₂H₄—OH (often known as DEODS). The sulfur content is generally between 0.1% and 2% by weight of the said element, with respect to the weight of the catalyst.

The stage of passivation by an oxygen compound or by CO₂ is generally carried out after a reducing treatment beforehand at high temperature, generally of between 350 and 500° C., and makes it possible to preserve the metallic phase of the catalyst in the presence of air. A second reducing treatment at lower temperature, generally between 120 and 350° C., is subsequently generally carried out. The oxygen compound is generally air or any other oxygen-containing stream.

Characteristics of the Catalyst

The catalyst obtained by the preparation process according to the invention is provided in the form of a composite comprising an oxide matrix having a content of calcined alumina of greater than or equal to 90% by weight, with respect to the total weight of the said matrix, within which is distributed the active phase comprising nickel, preferably consisting of nickel. The characteristics of the gel which has resulted in the production of the alumina present in the said oxide matrix, and also the textural properties obtained with the active phase, confer, on the catalyst, its specific properties.

More particularly, the said catalyst comprising an oxide matrix having a content of calcined alumina of greater than or equal to 90% by weight, with respect to the total weight of the said matrix, and an active phase comprising nickel, preferably consisting of nickel, the said active phase not comprising a metal from Group VIb (Cr, Mo, W), the content of nickel being between 1% and 65% by weight of the said element, with respect to the total weight of the catalyst, the said active phase being provided in the form of nickel particles having a diameter of less than or equal to 18 nm, the said catalyst comprising a total pore volume, measured by mercury porosimetry, of greater than 0.10 ml/g, a mesopore volume, measured by mercury porosimetry, of greater than 0.10 ml/g, a macropore volume, measured by mercury porosimetry, of less than or equal to 0.6 ml/g, a median mesopore diameter of between 3 and 25 nm, a median macropore diameter of between 50 and 1500 nm, and an SBET specific surface of between 20 and 400 m²/g. All the textural properties (total pore volume, mesopore volume, macropore volume, median mesopore diameter, median macropore diameter, specific surface) are measured on the dried catalyst (if the process for the preparation of the catalyst does not provide the optional heat treatment stage e) after the drying stage d)) or on the catalyst obtained after the heat treatment stage e) (if this stage is carried out).

The nickel content is between 1% and 65% by weight, preferably between 5% and 55% by weight, in a preferred way between 8% and 40% by weight, particularly preferably between 10% and 35% by weight, more preferably still between 12% and 35% by weight, even more preferably still between 15% and 35% by weight and more particularly preferably between 18% and 32% by weight of the said element, with respect to the total weight of the catalyst. The Ni content is measured by X-ray fluorescence.

The size of the nickel particles in the catalyst according to the invention measured in their oxide form, is less than 18 nm, preferably less than 15 nm, more preferably between 0.5 and 12 nm, preferably between 1 and 8 nm, more preferably still between 1 and 6 nm and more preferentially still between 1.5 and 5 nm. The active phase of the catalyst does not comprise a metal from Group VIb. In particular, it does not comprise molybdenum or tungsten.

Without wishing to be committed to any theory, it appears that the catalyst obtained by the preparation process as described above exhibits, when the latter is used in the context of the process for the selective hydrogenation of polyunsaturated compounds or for the hydrogenation of aromatics according to the invention, a good comprise between a high pore volume, a high mesopore volume and a high median mesopore diameter, a high Ni content and a small size of nickel particles, thus making it possible to have performance qualities in hydrogenation in terms of activity which are at least as good as the known catalysts of the prior state of the art.

The catalyst additionally comprises an oxide matrix having a content of calcined alumina of greater than or equal to 90% by weight, with respect to the total weight of the said matrix, optionally supplemented by silica and/or phosphorus at a total content of at most 10% by weight as SiO₂ and/or P₂O₅ equivalent, preferably less than 5% by weight and very preferably less than 2% by weight, with respect to the total weight of the said matrix. The silica and/or the phosphorus can be introduced by any technique known to a person skilled in the art, during the synthesis of the alumina gel or during the cokneading.

More preferably still, the oxide matrix consists of alumina.

Preferably, the alumina present in the said matrix is a transition alumina, such as a γ-, δ-, θ-, x-, ρ- or η-alumina, alone or as a mixture. More preferably, the alumina is a γ, δ or θ transition alumina, alone or as a mixture.

The said catalyst is generally presented in all the forms known to a person skilled in the art, for example in the form of beads (generally having a diameter of between 1 and 8 mm), of extrudates, of blocks or of hollow cylinders. Preferably, it consists of extrudates with a diameter generally of between 0.5 and 10 mm, preferably between 0.8 and 3.2 mm and very preferably between 1.0 and 2.5 mm and with a mean length of between 0.5 and 20 mm. “Mean diameter” of the extrudates is understood to mean the mean diameter of the circle circumscribed in the cross section of these extrudates. The catalyst can advantageously be presented in the form of cylindrical, multilobal, trilobal or quadrilobal extrudates. Preferably, its form will be trilobal or quadrilobal. The shape of the lobes can be adjusted according to all the methods known from the prior art.

The catalyst exhibits a total pore volume of at least 0.10 ml/g, preferably of at least 0.30 ml/g, in a preferred way of between 0.35 and 1.2 ml/g, more preferably between 0.4 and 1 ml/g and more preferably still between 0.45 and 0.9 ml/g.

The catalyst advantageously exhibits a macropore volume of less than or equal to 0.6 ml/g, preferably of less than or equal to 0.5 ml/g, more preferably of less than or equal to 0.4 ml/g and more preferably still between 0.02 and 0.3 ml/g.

The mesopore volume of the catalyst is at least 0.10 ml/g, preferably at least 0.20 ml/g, in a preferred way between 0.25 and 0.80 ml/g, more preferably between 0.30 and 0.65 ml/g and more preferably still between 0.35 and 0.55 ml/g.

The median mesopore diameter is between 3 and 25 nm, preferably between 6 and 20 nm and particularly preferably between 8 and 18 nm.

The catalyst exhibits a median macropore diameter of between 50 and 1500 nm, preferably between 80 and 1000 nm and more preferably still of between 250 and 800 nm.

The catalyst exhibits a BET specific surface of between 20 and 400 m²/g, more preferably between 30 and 350 m²/g and more preferably still between 40 and 250 m²/g. The specific surface is measured on the dried catalyst (if the process for the preparation of the catalyst does not provide the optional heat treatment stage e) after the drying stage d)) or on the catalyst obtained after the heat treatment stage e) (if this stage is carried out).

Preferably, the catalyst exhibits a low microporosity; very preferably, it does not exhibit any microporosity.

Description of the Process for the Selective Hydrogenation of Polyunsaturated Compounds

Another subject-matter of the present invention is a process for the selective hydrogenation of polyunsaturated compounds containing at least 2 carbon atoms per molecule, such as diolefins and/or acetylenics and/or alkenylaromatics, also known as styrenics, present in a hydrocarbon feedstock having a final boiling point of less than or equal to 300° C., which process being carried out at a temperature of between 0 and 300° C., at a pressure of between 0.1 and 10 MPa, at a hydrogen/(polyunsaturated compounds to be hydrogenated) molar ratio of between 0.1 and 10 and at an hourly space velocity of between 0.1 and 200 h⁻¹ when the process is carried out in the liquid phase, or at a hydrogen/(polyunsaturated compounds to be hydrogenated) molar ratio of between 0.5 and 1000 and at an hourly space velocity between 100 and 40 000 h⁻¹ when the process is carried out in the gas phase, in the presence of a catalyst obtained by the preparation process as described above in the description.

Monounsaturated organic compounds, such as, for example, ethylene and propylene, are at the root of the manufacture of polymers, of plastics and of other chemicals having added value. These compounds are obtained from natural gas, from naphtha or from gas oil which were treated by steam cracking or catalytic cracking processes. These processes are carried out at high temperature and produce, in addition to the desired monounsaturated compounds, polyunsaturated organic compounds, such as acetylene, propadiene and methylacetylene (or propyne), 1,2-butadiene and 1,3-butadiene, vinylacetylene and ethylacetylene, and other polyunsaturated compounds, the boiling point of which corresponds to the C5+ fraction (hydrocarbon compounds having at least 5 carbon atoms), in particular diolefinic or styrene or indene compounds. These polyunsaturated compounds are highly reactive and result in side reactions in the polymerization units. It is thus necessary to remove them before making economic use of these fractions.

Selective hydrogenation is the main treatment developed to specifically remove undesirable polyunsaturated compounds from these hydrocarbon feedstocks. It makes possible the conversion of polyunsaturated compounds to the corresponding alkenes or aromatics while avoiding their complete saturation and thus the formation of the corresponding alkanes or naphthenes. In the case of steam cracking petrols used as feedstock, the selective hydrogenation also makes it possible to selectively hydrogenate the alkenylaromatics to give aromatics while avoiding the hydrogenation of the aromatic nuclei.

The hydrocarbon feedstock treated in the selective hydrogenation process has a final boiling point of less than or equal to 300° C. and contains at least 2 carbon atoms per molecule and comprises at least one polyunsaturated compound. “Polyunsaturated compounds” is understood to mean compounds comprising at least one acetylenic functional group and/or at least one diene functional group and/or at least one alkenylaromatic functional group.

More particularly, the feedstock is selected from the group consisting of a steam cracking C2 fraction, a steam cracking C2-C3 fraction, a steam cracking C3 fraction, a steam cracking C4 fraction, a steam cracking C5 fraction and a steam cracking petrol, also known as pyrolysis gasoline or C5+ fraction.

The steam cracking C2 fraction, advantageously used for the implementation of the selective hydrogenation process according to the invention, exhibits, for example, the following composition: between 40% and 95% by weight of ethylene and of the order of 0.1% to 5% by weight of acetylene, the remainder being essentially ethane and methane. In some steam cracking C2 fractions, between 0.1% and 1% by weight of C3 compounds may also be present.

The steam cracking C3 fraction, advantageously used for the implementation of the selective hydrogenation process according to the invention, exhibits, for example, the following mean composition: of the order of 90% by weight of propylene and of the order of 1% to 8% by weight of propadiene and of methylacetylene, the remainder being essentially propane. In some C3 fractions, between 0.1% and 2% by weight of C2 compounds and of C4 compounds may also be present.

A C2-C3 fraction can also advantageously be used for the implementation of the selective hydrogenation process according to the invention. It exhibits, for example, the following composition: of the order of 0.1% to 5% by weight of acetylene, of the order of 0.1% to 3% by weight of propadiene and of methylacetylene, of the order of 30% by weight of ethylene and of the order of 5% by weight of propylene, the remainder being essentially methane, ethane and propane. This feedstock may also contain between 0.1% and 2% by weight of C4 compounds.

The steam cracking C4 fraction, advantageously used for the implementation of the selective hydrogenation process according to the invention, exhibits, for example, the following mean composition by weight: 1% by weight of butane, 46.5% by weight of butene, 51% by weight of butadiene, 1.3% by weight of vinylacetylene and 0.2% by weight of butyne. In some C4 fractions, between 0.1% and 2% by weight of C3 compounds and of C5 compounds may also be present.

The steam cracking C5 fraction, advantageously used for the implementation of the selective hydrogenation process according to the invention, exhibits, for example, the following composition: 21% by weight of pentanes, 45% by weight of pentenes and 34% by weight of pentadienes.

The steam cracking petrol or pyrolysis gasoline, advantageously used for the implementation of the selective hydrogenation process according to the invention, corresponds to a hydrocarbon fraction, the boiling point of which is generally between 0 and 300° C., preferably between 10 and 250° C. The polyunsaturated hydrocarbons to be hydrogenated present in the said steam cracking petrol are in particular diolef in compounds (butadiene, isoprene, cyclopentadiene, and the like), styrene compounds (styrene, α-methylstyrene, and the like) and indene compounds (indene, and the like). The steam cracking petrol generally comprises the C5-C12 fraction with traces of C3, C4, C13, C14 and C15 (for example between 0.1% and 3% by weight for each of these fractions). For example, a feedstock formed of pyrolysis gasoline generally has a following composition: 5% to 30% by weight of saturated compounds (paraffins and naphthenes), 40% to 80% by weight of aromatic compounds, 5% to 20% by weight of mono-olefins, 5% to 40% by weight of diolefins and 1% to 20% by weight of alkenylaromatic compounds, the combined compounds forming 100%. It also contains from 0 to 1000 ppm by weight of sulfur, preferably from 0 to 500 ppm by weight of sulfur.

Preferably, the polyunsaturated hydrocarbon feedstock treated in accordance with the selective hydrogenation process according to the invention is a steam cracking C2 fraction or a steam cracking C2-C3 fraction or a steam cracking petrol.

The selective hydrogenation process according to the invention is targeted at removing the said polyunsaturated hydrocarbons present in the said feedstock to be hydrogenated without hydrogenating the monounsaturated hydrocarbons. For example, when the said feedstock is a C2 fraction, the selective hydrogenation process is targeted at selectively hydrogenating acetylene. When the said feedstock is a C3 fraction, the selective hydrogenation process is targeted at selectively hydrogenating propadiene and methylacetylene. In the case of a C4 fraction, the aim is to remove butadiene, vinylacetylene (VAC) and butyne; in the case of a C5 fraction, the aim is to remove the pentadienes. When the said feedstock is a steam cracking petrol, the selective hydrogenation process is targeted at selectively hydrogenating the said polyunsaturated hydrocarbons present in the said feedstock to be treated so that the diolefin compounds are partially hydrogenated to give mono-olefins and so that the styrene and indene compounds are partially hydrogenated to give corresponding aromatic compounds while avoiding the hydrogenation of the aromatic nuclei.

The technological implementation of the selective hydrogenation process is, for example, carried out by injection, as ascending or descending stream, of the polyunsaturated hydrocarbon feedstock and of the hydrogen into at least one fixed bed reactor. The said reactor can be of isothermal type or of adiabatic type. An adiabatic reactor is preferred. The feedstock of polyunsaturated hydrocarbons can advantageously be diluted by one or more reinjection(s) of the effluent, resulting from the said reactor where the selective hydrogenation reaction takes place, at various points of the reactor, located between the inlet and the outlet of the reactor, in order to limit the temperature gradient in the reactor. The technological implementation of the selective hydrogenation process according to the invention can also advantageously be carried out by the implantation of at least of the said supported catalyst in a reactive distillation column or in reactors-exchangers or in a slurry-type reactor. The stream of hydrogen can be introduced at the same time as the feedstock to be hydrogenated and/or at one or more different points of the reactor.

The selective hydrogenation of the steam cracking C2, C2-C3, C3, C4, C5 and C5+ fractions can be carried out in the gas phase or in the liquid phase, preferably in the liquid phase for the C3, C4, C5 and C5+ fractions and in the gas phase for the C2 and C2-C3 fractions. A liquid-phase reaction makes it possible to lower the energy cost and to increase the cycle period of the catalyst.

Generally, the selective hydrogenation of a hydrocarbon feedstock containing polyunsaturated compounds containing at least 2 carbon atoms per molecule and having a final boiling point of less than or equal to 300° C. is carried out at a temperature of between 0 and 300° C., at a pressure of between 0.1 and 10 MPa, at a hydrogen/(polyunsaturated compounds to be hydrogenated) molar ratio of between 0.1 and 10 and at an hourly space velocity HSV (defined as the ratio of the flow rate by volume of feedstock to the volume of the catalyst) of between 0.1 and 200 h⁻¹ for a process carried out in the liquid phase, or at a hydrogen/(polyunsaturated compounds to be hydrogenated) molar ratio of between 0.5 and 1000 and at an hourly space velocity HSV of between 100 and 40 000 h⁻¹ for a process carried out in the gas phase.

In one embodiment according to the invention, when a selective hydrogenation process is carried out in which the feedstock is a steam cracking petrol comprising polyunsaturated compounds, the (hydrogen)/(polyunsaturated compounds to be hydrogenated) molar ratio is generally between 0.5 and 10, preferably between 0.7 and 5.0 and more preferably still between 1.0 and 2.0, the temperature is between 0 et 200° C., preferably between 20 and 200° C. and more preferably still between 30 and 180° C., the hourly space velocity (HSV) is generally between 0.5 and 100 h⁻¹, preferably between 1 and 50 h⁻¹, and the pressure is generally between 0.3 and 8.0 MPa, preferably between 1.0 and 7.0 MPa and more preferably still between 1.5 and 4.0 MPa.

More preferably, a selective hydrogenation process is carried out in which the feedstock is a steam cracking petrol comprising polyunsaturated compounds, the hydrogen/(polyunsaturated compounds to be hydrogenated) molar ratio is between 0.7 and 5.0, the temperature is between 20 and 200° C., the hourly space velocity (HSV) is generally between 1 and 50 h⁻¹ and the pressure is between 1.0 and 7.0 MPa.

More preferably still, a selective hydrogenation process is carried out in which the feedstock is a steam cracking petrol comprising polyunsaturated compounds, the hydrogen/(polyunsaturated compounds to be hydrogenated) molar ratio is between 1.0 and 2.0, the temperature is between 30 and 180° C., the hourly space velocity (HSV) is generally between 1 and 50 h⁻¹ and the pressure is between 1.5 and 4.0 MPa.

The hydrogen flow rate is adjusted in order to have available a sufficient amount thereof to theoretically hydrogenate all of the polyunsaturated compounds and to maintain an excess of hydrogen at the reactor outlet.

In another embodiment according to the invention, when a selective hydrogenation process is carried out in which the feedstock is a steam cracking C2 fraction and/or a steam cracking C2-C3 fraction comprising polyunsaturated compounds, the (hydrogen)/(polyunsaturated compounds to be hydrogenated) molar ratio is generally between 0.5 and 1000, preferably between 0.7 and 800, the temperature is between 0 et 300° C., preferably between 15 and 280° C., the hourly space velocity (HSV) is generally between 100 and 40 000 h⁻¹, preferably between 500 and 30 000 h⁻¹, and the pressure is generally between 0.1 and 6.0 MPa, preferably between 0.2 and 5.0 MPa.

Description of the Process for the Hydrogenation of the Aromatics

Another subject-matter of the present invention is a process for the hydrogenation of at least one aromatic or polyaromatic compound present in a hydrocarbon feedstock having a final boiling point of less than or equal to 650° C., generally between 20 and 650° C. and preferably between 20 and 450° C. The said hydrocarbon feedstock containing at least one aromatic or polyaromatic compound can be chosen from the following petroleum or petrochemical fractions: the ref ormate from catalytic reforming, kerosene, light gas oil, heavy gas oil, cracking distillates, such as FCC cycle oil, coking unit gas oil or hydrocracking distillates. The content of aromatic or polyaromatic compounds present in the hydrocarbon feedstock treated in the hydrogenation process according to the invention is generally between 0.1% and 80% by weight, preferably between 1% and 50% by weight and particularly preferably between 2% and 35% by weight, the percentage being based on the total weight of the hydrocarbon feedstock. The aromatic compounds present in the said hydrocarbon feedstock are, for example, benzene or alkylaromatics, such as toluene, ethylbenzene, o-xylene, m-xylene or p-xylene, or also aromatics having several aromatic nuclei (polyaromatics), such as naphthalene.

The sulfur or chlorine content of the feedstock is generally less than 5000 ppm by weight of sulfur or chlorine, preferably less than 100 ppm by weight and particularly preferably less than 10 ppm by weight.

The technological implementation of the process for the hydrogenation of aromatic or polyaromatic compounds is, for example, carried out by injection, as ascending or descending stream, of the hydrocarbon feedstock and of the hydrogen into at least one fixed bed reactor. The said reactor can be of isothermal type or of adiabatic type. An adiabatic reactor is preferred. The hydrocarbon feedstock can advantageously be diluted by one or more reinjection(s) of the effluent, resulting from the said reactor where the reaction for the hydrogenation of the aromatics takes place, at various points of the reactor, located between the inlet and the outlet of the reactor, in order to limit the temperature gradient in the reactor. The technological implementation of the process for the hydrogenation of the aromatics according to the invention can also advantageously be carried out by the implantation of at least of the said supported catalyst in a reactive distillation column or in reactors-exchangers or in a slurry-type reactor. The stream of hydrogen can be introduced at the same time as the feedstock to be hydrogenated and/or at one or more different points of the reactor.

The hydrogenation of the aromatic or polyaromatic compounds can be carried out in the gas phase or in the liquid phase, preferably in the liquid phase. Generally, the hydrogenation of the aromatic or polyaromatic compounds is carried out at a temperature of between 30 and 350° C., preferably between 50 and 325° C., at a pressure of between 0.1 and 20 MPa, preferably between 0.5 and 10 MPa, at a hydrogen/(aromatic compounds to be hydrogenated) molar ratio between 0.1 and 10 and at an hourly space velocity HSV of between 0.05 and 50 h⁻¹, preferably between 0.1 and 10 h⁻¹, of a hydrocarbon feedstock containing aromatic or polyaromatic compounds and having a final boiling point of less than or equal to 650° C., generally between 20 and 650° C. and preferably between 20 and 450° C.

The hydrogen flow rate is adjusted in order to have available a sufficient amount thereof to theoretically hydrogenate all of the aromatic compounds and to maintain an excess of hydrogen at the reactor outlet.

The conversion of the aromatic or polyaromatic compounds is generally greater than 20 mol %, preferably greater than 40 mol %, more preferably greater than 80 mol % and particularly preferably greater than 90 mol % of the aromatic or polyaromatic compounds present in the hydrocarbon feedstock. The conversion is calculated by dividing the difference between the total moles of the aromatic or polyaromatic compounds in the hydrocarbon feedstock and in the product by the total moles of the aromatic or polyaromatic compounds in the hydrocarbon feedstock.

According to a specific alternative form of the process according to the invention, a process for the hydrogenation of the benzene of a hydrocarbon feedstock, such as the reformate resulting from a catalytic reforming unit, is carried out. The benzene content in the said hydrocarbon feedstock is generally between 0.1% and 40% by weight, preferably between 0.5% and 35% by weight and particularly preferably between 2% and 30% by weight, the percentage by weight being based on the total weight of the hydrocarbon feedstock. The sulfur or chlorine content of the feedstock is generally less than 10 ppm by weight of sulfur or chlorine respectively and preferably less than 2 ppm by weight.

The hydrogenation of the benzene present in hydrocarbon feedstock can be carried out in the gas phase or in the liquid phase, preferably in the liquid phase. When it is carried out in the liquid phase, a solvent can be present, such as cyclohexane, heptane or octane. Generally, the hydrogenation of the benzene is carried out at a temperature of between 30 and 250° C., preferably between 50 and 200° C. and more preferably between 80 and 180° C., at a pressure of between 0.1 and 10 MPa, preferably between 0.5 and 4 MPa, at a hydrogen/(benzene) molar ratio between 0.1 and 10 and at an hourly space velocity HSV of between 0.05 and 50 h⁻¹, preferably between 0.5 and 10 h⁻¹.

The conversion of the benzene is generally greater than 50 mol %, preferably greater than 80 mol %, more preferably greater than 90 mol % and particularly preferably greater than 98 mol %.

The invention is illustrated by the examples which follow.

### Example 1: Preparation of an Aqueous Solution of Ni Precursors

The aqueous solution of Ni precursors (solution S) used for the preparation of the catalysts B and C is prepared by dissolving 46.1 g of nickel nitrate (Ni(NO₃)₂.6H₂O, supplied by Strem Chemicals®) in a volume of 13 ml of distilled water. The solution S, the NiO concentration of which is 20.1% by weight (with respect to the weight of the solution), is obtained.

### Example 2: Preparation of a Calcined Porous Aluminium Oxide (According to Embodiment 2)

The alumina A is synthesized in a laboratory reactor with a capacity of approximately 7000 ml. The synthesis takes place at 70° C. and with stirring, in six stages, named a1′) to a6′) below. The aim is to prepare 5 l of solution at a concentration fixed at 27 g/l of alumina in the final suspension (obtained on conclusion of stage a3′)) and with a degree of contribution of the first stage (a1′) at 2.1% of the total alumina.

a1′) Dissolution: 70 ml of aluminium sulfate Al₂(SO₄)₃ are introduced, in one go, into the reactor containing a water heel of 1679 ml. The change in the pH, which remains between 2.5 and 3, is monitored for 10 minutes. This stage contributes to the introduction of 2.1% of alumina, with respect to the total weight of alumina formed on conclusion of the synthesis of the gel. The solution is left stirring for a period of time of 10 minutes.

a2′) Adjustment of the pH: Approximately 70 mL of sodium aluminate NaAlOO are gradually added. The objective is to achieve a pH of between 7 and 10 in a period of time of 5 to 15 minutes.

a3′) Coprecipitation: The following are added, in 30 minutes, to the suspension obtained on conclusion of stage a2′):
1020 ml of aluminium sulfate Al₂(SO₄)₃, i.e. a flow rate of 34 ml/min,
1020 ml of sodium aluminate NaAlOO, i.e. a flow rate of 34 ml/min,
1150 ml of distilled water, i.e. a flow rate of 38.3 ml/min.

The pH is between 8.7 and 9.9.

a4′) Filtration: The suspension obtained on conclusion of stage a3′) is filtered by displacement on a device of sintered Büchner P4 type and washed several times with distilled water. An alumina gel is obtained.

a5′) Drying: The alumina gel obtained on conclusion of stage a4′) is dried in an oven at 200° C. for 16 hours.

a6′) Heat treatment: The powder obtained on conclusion of stage a5′) is subsequently calcined under a stream of air of 1 l/h/g of alumina gel at 750° C. for 2 hours in order to obtain the transition of the boehmite to alumina. The alumina A is then obtained.

### Example 3 (Comparative): Preparation of a Catalyst B by Impregnation of Nickel Nitrate without Additive

The catalyst B is prepared by impregnation under dry conditions of the alumina A described in Example 2 with the solution S of Ni precursors.

The alumina A is synthesized by following the six stages, stages a1′) to a6′), of Example 2 described above. The operating conditions are strictly identical. However, a stage of shaping the dried alumina gel resulting from stage a5′) is inserted between stages a5′) and a6′). The shaping of this powder is carried out on a kneader of “Brabender” type with an acid content of 1% (total acid content, expressed with respect to the dry alumina), a degree of neutralization of 20% and acidic and basic losses on ignition respectively of 62% and 64%. The extrusion is then carried out on a piston extruder through a die with a diameter of 2.1 mm. After extrusion, the extrudates are dried at 80° C. for 16 hours. On conclusion of the calcination stage a6′), extrudates of the alumina A are obtained.

The solution S prepared in Example 1 is impregnated under dry conditions on 10 g of alumina A. The solid thus obtained is subsequently dried in an oven at 120° C. for 16 hours and then calcined under a stream of air of 1 I/h/g of catalyst at 450° C. for 2 hours.

The calcined catalyst B thus prepared contains 23.2% by weight of the element nickel with respect to the total weight of the catalyst supported on alumina and it exhibits nickel oxide crystallites, the mean diameter of which (determined by X-ray diffraction from the width of the diffraction line located at the angle 20=43°) is 15.6 nm. The other structural characteristics of the catalyst B are listed in Table 1 below.

### Example 4 (Comparative): Preparation of a Catalyst C by Cokneading without Additive

The catalyst C is prepared from the alumina A and from the solution S of Ni precursor, which are prepared above, according to the following four stages:

Cokneading: A “Brabender” kneader with a vessel of 80 ml and a kneading rate of 30 rev/min is used. The alumina A powder is placed in the vessel of the kneader. The solution S of Ni precursors is then added as it is used up with a syringe for approximately 10 minutes at 15 rev/min while heating in order to discharge the water. After a paste is obtained, the kneading is maintained at 50 rev/min for 15 minutes.

Extrusion: The paste thus obtained is introduced into a piston extruder and is extruded through a die with a diameter of 2.1 mm.

Drying: The extrudates thus obtained are subsequently dried in an oven at 80° C. for 16 hours. A dried catalyst is obtained.

Heat treatment: The dried catalyst is subsequently calcined in a tubular furnace under a stream of air of 1 I/h/g of catalyst at 450° C. for 2 hours (temperature rise gradient of 5° C./min).

The calcined catalyst C, which contains 24.3% by weight of the element nickel, with respect to the total weight of the cokneaded catalyst, is then obtained and exhibits nickel oxide crystallites, the mean diameter of which is 9.5 nm. The other structural characteristics of the catalyst C are listed in Table 1 below.

### Example 5 (Comparative): Preparation of a Catalyst D by Coimpregnation of Nickel Nitrate and of Propanedioic Acid (Malonic Acid)

The catalyst D is prepared by coimpregnation under dry conditions of nickel nitrate and of malonic acid on alumina A using a {malonic acid/nickel} molar ratio equal to 0.6. In order to do this, an aqueous solution S′ is prepared by dissolving 89.0 g of nickel nitrate Ni(NO₃)₂.6H₂O (supplier Strem Chemicals®) and 19.1 g of malonic acid (CAS 141-82-2, supplier Fluka®) in 20 ml of demineralized water. This solution S′ is subsequently impregnated under dry conditions on 10 g of alumina A shaped beforehand in the form of extrudates as described above in Example 3. The solid thus obtained is subsequently dried in an oven at 120° C. for 16 hours and then calcined under a stream of air of 1 I/h/g of catalyst at 450° C. for 2 hours.

The calcined catalyst D thus prepared contains 22.9% by weight of the element nickel with respect to the total weight of the catalyst supported on alumina and it exhibits nickel oxide crystallites, the mean diameter of which is 4.8 nm. The other structural characteristics of the catalyst D are listed in Table 1 below.

### Example 6 (in Accordance): Preparation of a Catalyst E by Cokneading in the Presence of Propanedioic Acid

The catalyst E is prepared from the alumina A and from the solution S′ containing the Ni precursor and the propanedioic acid, which are prepared above, according to the following four stages:

Cokneading: A “Brabender” kneader with a vessel of 80 ml and a kneading rate of 30 rev/min is used. The alumina A powder is placed in the vessel of the kneader. The solution S′ of Ni precursor and of propanedioic acid is then added as it is used up with a syringe for approximately 10 minutes at 15 rev/min while heating in order to discharge the water. After a paste is obtained, the kneading is maintained at 50 rev/min for 15 minutes.

Extrusion: The paste thus obtained is introduced into a piston extruder and is extruded through a die with a diameter of 2.1 mm.

Drying: The extrudates thus obtained are subsequently dried in an oven at 80° C. for 16 hours. A dried catalyst is obtained.

Heat treatment: The dried catalyst is subsequently calcined in a tubular furnace under a stream of air of 1 I/h/g of catalyst at 450° C. for 2 hours (temperature rise gradient of 5° C./min).

The calcined catalyst E, which contains 27.7% by weight of the element nickel, with respect to the total weight of the cokneaded catalyst, is then obtained and exhibits nickel oxide crystallites, the mean diameter of which is 4.2 nm. The other structural characteristics of the catalyst E are listed in Table 1 below.

TABLE 1
Properties of the catalysts B, C and D (not in accordance with the
preparation process according to the invention) and E (in accordance)

| | B | C | D | E |
|---|---|---|---|---|
| | Comparative | Comparative | Comparative | In |
| | | | | accordance |
| Alumina precursor | Calcined | Calcined | Calcined | Calcined |
| Form of | Impregnation | Cokneading | Impregnation | Cok- |
| introduction | under dry | | under dry | neading |
| of the Ni | conditions | | conditions | |
| Additive used | — | — | Malonic | Malonic |
| | | | acid | acid |
| Ni (% by weight) | 23.2 | 24.3 | 22.9 | 27.7 |
| BET surface | 156 | 155 | 152 | 125 |
| (m²/g) | | | | |
| Total pore volume | 0.66 | 0.67 | 0.64 | 0.59 |
| (ml/g) | | | | |
| Mesopore volume | 0.47 | 0.47 | 0.42 | 0.36 |
| (ml/g) | | | | |
| Median mesopore | 11.5 | 12.0 | 11.3 | 11.8 |
| diameter (nm) | | | | |
| Macropore | 0.19 | 0.20 | 0.19 | 0.23 |
| volume | | | | |
| (ml/g and % | 29% | 32% | 29% | 38% |
| of the total | | | | |
| pore volume) | | | | |
| Median | 638 | 435 | 610 | 360 |
| macropore | | | | |
| diameter (nm) | | | | |
| Micropore | 0 | 0 | 0 | 0 |
| volume (ml/g) | | | | |
| Size of the NiO | 15.6 | 9.5 | 4.8 | 4.2 |
| crystallites (nm) | | | | |

### Example 7: Evaluation of the Catalytic Properties of the Catalysts B, C, D and E in the Selective Hydrogenation of a Mixture Containing Styrene and Isoprene

The catalysts B, C, D and E described in the above examples are tested with regard to the reaction for the selective hydrogenation of a mixture containing styrene and isoprene.

The composition of the feedstock to be selectively hydrogenated is as follows: 8% by weight of styrene (supplied by Sigma Aldrich®, purity 99%), 8% by weight of isoprene (supplied by Sigma Aldrich®, purity 99%) and 84% by weight of n-heptane (solvent) (supplied by VWR®, purity >99% Chromanorm HPLC). This feedstock also contains sulfur compounds in a very small content: 10 ppm by weight of sulfur introduced in the form of pentanethiol (supplied by Fluka®, purity >97%) and 100 ppm by weight of sulfur introduced in the form of thiophene (supplied by Merck®, purity 99%). This composition corresponds to the initial composition of the reaction mixture. This mixture of model molecules is representative of a pyrolysis gasoline.

The selective hydrogenation reaction is carried out in a 500 ml stainless steel autoclave which is provided with a magnetically-driven mechanical stirrer and which is able to operate under a maximum pressure of 100 bar (10 MPa) and temperatures of between 5° C. and 200° C.

Prior to its introduction into the autoclave, an amount of 3 ml of catalyst is reduced ex situ under a stream of hydrogen of 1 I/h/g of catalyst at 400° C. for 16 hours (temperature rise gradient of 1° C./min) and then it is transferred into the autoclave, with the exclusion of air. After addition of 214 ml of n-heptane (supplied by VWR®, purity >99% Chromanorm HPLC), the autoclave is closed, purged, then pressurized under 35 bar (3.5 MPa) of hydrogen and brought to the temperature of the test, which is equal to 30° C. At the time t=0, approximately 30 g of a mixture containing styrene, isoprene, n-heptane, pentanethiol and thiophene are introduced into the autoclave. The reaction mixture then has the composition described above and stirring is started at 1600 rev/min. The pressure is kept constant at 35 bar (3.5 MPa) in the autoclave using a storage cylinder located upstream of the reactor.

The progress of the reaction is monitored by taking samples from the reaction medium at regular time intervals: the styrene is hydrogenated to give ethylbenzene, without hydrogenation of the aromatic ring, and the isoprene is hydrogenated to give methylbutenes. If the reaction is prolonged for longer than necessary, the methylbutenes are in their turn hydrogenated to give isopentane. The hydrogen consumption is also monitored over time by the decrease in pressure in a storage cylinder located upstream of the reactor. The catalytic activity is expressed in moles of H₂ consumed per minute and per gram of Ni.

The catalytic activities measured for the catalysts B, C, D and E are given in Table 2 below. They are with reference to the catalytic activity measured for the catalyst B (A_{HYD1}).

TABLE 2
Comparison of the performance qualities in the selective hydrogenation
of a mixture containing styrene and isoprene (A_{HYD1}) and in the
hydrogenation of toluene (A_{HYD2})

| | | | % by | | | |
|---|---|---|---|---|---|---|
| | | | weight | | | |
| | | | of NiO | | | |
| | | Form of | with | | | |
| | | introduction | regard | Mean size | | |
| | | of the Ni | to | of the NiO | | |
| | Additive | and of | final | crystallites | A_{HYD1} | A_{HYD2} |
| Catalyst | used | the additive | catalyst | (nm) | (%) | (%) |
| B (not in | — | Impregnation | 23.2 | 15.6 | 100 | 100 |
| accordance) | | under dry | | | | |
| | | conditions | | | | |
| C (not in | — | Cokneading | 24.3 | 9.5 | 176 | 190 |
| accordance) | | | | | | |
| D (not in | Malonic | Impregnation | 22.9 | 4.8 | 260 | 327 |
| accordance) | acid | under dry | | | | |
| | | conditions | | | | |
| E (in | Malonic | Cokneading | 27.7 | 4.2 | 341 | 458 |
| accordance) | acid | | | | | |

This clearly shows the improved performance qualities of the catalyst E prepared according to the invention and in particular the impact of resorting to a stage of kneading of the active phase in the presence of an organic additive rather than an impregnation stage. This is because the catalyst D, although having NiO crystallites which are substantially equal in size to those of the catalyst E, has poorer catalytic performance qualities. Furthermore, the addition of a specific organic compound during the kneading stage makes it possible to obtain improved performance qualities (with respect to the activity of the catalyst C not in accordance, which is prepared by a process without addition of malonic acid during the kneading stage). The high content of element nickel and the Ni particles of very small size present with regard to the catalyst E prepared according to the invention by kneading of the active phase in the presence of an organic additive are also noted.

### Example 8: Evaluation of the Catalytic Properties of the Catalysts B, C, D and E in the Hydrogenation of Toluene

The catalysts B, C, D, and E described in the above examples are also tested with regard to the reaction for the hydrogenation of toluene.

The selective hydrogenation reaction is carried out in the same autoclave as that described in Example 7.

Prior to its introduction into the autoclave, an amount of 2 ml of catalyst is reduced ex situ under a stream of hydrogen of 1 I/h/g of catalyst at 400° C. for 16 hours (temperature rise gradient of 1° C./min) and then it is transferred into the autoclave, with the exclusion of air. After addition of 216 ml of n-heptane (supplied by VWR®, purity >99% Chromanorm HPLC), the autoclave is closed, purged, then pressurized under 35 bar (3.5 MPa) of hydrogen and brought to the temperature of the test, which is equal to 80° C. At the time t=0, approximately 26 g of toluene (supplied by SDS®, purity >99.8%) are introduced into the autoclave (the initial composition of the reaction mixture is then toluene 6% by weight/n-heptane 94% by weight) and stirring is started at 1600 rev/min. The pressure is kept constant at 35 bar (3.5 MPa) in the autoclave using a storage cylinder located upstream of the reactor.

The progress of the reaction is monitored by taking samples from the reaction medium at regular time intervals: the toluene is completely hydrogenated to give methylcyclohexane. The hydrogen consumption is also monitored over time by the decrease in pressure in a storage cylinder located upstream of the reactor. The catalytic activity is expressed in moles of H₂ consumed per minute and per gram of Ni.

The catalytic activities measured for the catalysts B, C, D, and E are given in Table 2 above. They are with reference to the catalytic activity measured for the catalyst B (A_{HYD2}).

This clearly shows the improved performance qualities of the catalyst E prepared according to the invention and in particular the impact of resorting to a stage of kneading of the active phase in the presence of an organic additive rather than an impregnation stage. This is because the catalyst D, although having NiO crystallites which are substantially equal in size to those of the catalyst E, has poorer catalytic performance qualities. Furthermore, the addition of a specific organic compound during the kneading stage makes it possible to obtain improved performance qualities (with respect to the activity of the catalyst C not in accordance, which is prepared by a process without addition of malonic acid during the kneading stage). The high content of element nickel and the Ni particles of very small size present with regard to the catalyst E prepared according to the invention by kneading of the active phase in the presence of an organic additive are also noted.

1. Process for the preparation of a catalyst comprising an oxide matrix having a content of calcined alumina of greater than or equal to 90% by weight, with respect to the total weight of the said matrix, and an active phase comprising nickel, the said active phase not comprising a metal from Group VIb, the content of nickel being between 1% and 65% by weight of the said element, with respect to the total weight of the catalyst, the said active phase being provided in the form of nickel particles having a diameter of less than or equal to 18 nm, the said catalyst comprising a total pore volume, measured by mercury porosimetry, of greater than 0.10 ml/g, a mesopore volume, measured by mercury porosimetry, of greater than 0.10 ml/g, a macropore volume, measured by mercury porosimetry, of less than or equal to 0.6 ml/g, a median mesopore diameter of between 3 and 25 nm, a median macropore diameter of between 50 and 1500 nm, and an SBET specific surface of between 20 and 400 m²/g, which process comprises the following stages:
a) a calcined porous aluminium oxide is prepared;
b) the calcined porous aluminium oxide obtained in stage a) is kneaded with a solution resulting from a mixing of one or more solution(s) comprising at least one nickel precursor and at least one solution comprising at least one organic compound comprising at least one carboxylic acid functional group, or at least one alcohol functional group, or at least one ester functional group, or at least one amine functional group, or at least one amide functional group, in order to obtain a paste, the molar ratio of the said organic compound to the element nickel being between 0.01 and 5.0 mol/mol;
c) the paste obtained in stage b) is shaped;
d) the shaped paste obtained in stage c) is dried at a temperature of less than 250° C. in order to obtain a dried catalyst;
e) optionally, a heat treatment of the dried catalyst obtained in stage d) is carried out at a temperature of between 250 and 1000° C., in the presence or absence of water.

2. Process according to claim 1, characterized in that the said organic compound comprises at least one carboxylic acid functional group.

3. Process according to claim 2, characterized in that the said organic compound is chosen from monocarboxylic acids, dicarboxylic acids, tricarboxylic acids or tetracarboxylic acids.

4. Process according to claim 1, characterized in that the said organic compound comprises at least one alcohol functional group.

5. Process according to claim 4, in which the said organic compound is chosen from:
organic compounds comprising just one alcohol functional group;
organic compounds comprising two alcohol functional groups;
organic compounds chosen from diethylene glycol, triethylene glycol, tetraethylene glycol or a polyethylene glycol corresponding to the formula H(OC₂H₄)ₙOH with n greater than 4 and having an average molar mass of less than 20 000 g/mol;
monosaccharides of empirical formula Cₙ(H₂O)ₚ with n between 3 and 12;
disaccharides, trisaccharides or monosaccharide derivatives.

6. Process according to claim 1, characterized in that the said organic compound comprises at least one ester functional group.

7. Process according to claim 6, in which the said organic compound is chosen from:
carboxylic acid linear or cyclic or unsaturated cyclic esters;
organic compounds comprising at least two carboxylic acid ester functional groups;
organic compounds comprising at least one carboxylic acid ester functional group and at least one second functional group chosen from alcohols, ethers, ketones or aldehydes;
carbonic acid cyclic or linear esters;
carbonic acid linear diesters.

8. Process according to claim 1, characterized in that the said organic compound comprises at least one amide functional group.

9. Process according to claim 8, in which the said organic compound is chosen from:
acyclic amides comprising one or two amide functional groups;
cyclic amides or lactams;
organic compounds comprising at least one amide functional group and a carboxylic acid functional group or an alcohol functional group;
organic compounds comprising at least one amide functional group and an additional nitrogen heteroatom.

10. Process according to claim 1, in which the said organic compound comprises at least one amine functional group corresponding to the empirical formula Cₓ N_{y}H_{z} in which x is between 1 and 20, y=1−x and z=2−(2x+2).

11. Process according to claim 1, in which the said calcined porous aluminium oxide according to stage a) is obtained by the following stages:
a1) a first stage of precipitation, in an aqueous reaction medium, of at least one basic precursor chosen from sodium aluminate, potassium aluminate, ammonia, sodium hydroxide and potassium hydroxide and of at least one acidic precursor chosen from aluminium sulfate, aluminium chloride, aluminium nitrate, sulfuric acid, hydrochloric acid and nitric acid, in which at least one of the basic or acidic precursors comprises aluminium, the relative flow rates of the acidic and basic precursors are chosen so as to obtain a pH of the reaction medium of between 8.5 and 10.5 and the flow rates of the acidic and basic precursor or precursors containing aluminium are adjusted so as to obtain a degree of progression of the first stage of between 5% and 13%, the degree of progression being defined as being the proportion of alumina formed as Al₂O₃ equivalent during the said first precipitation stage, with respect to the total amount of alumina formed on conclusion of stage a3) of the preparation process, the said stage being carried out at a temperature of between 20 and 90° C. and for a period of time of between 2 minutes and 30 minutes;
a2) a stage of heating the suspension at a temperature of between 40 and 90° C. for a period of time of between 7 minutes and 45 minutes;
a3) a second stage of precipitation of the suspension obtained on conclusion of the heating stage a2) by addition, to the suspension, of at least one basic precursor chosen from sodium aluminate, potassium aluminate, ammonia, sodium hydroxide and potassium hydroxide and of at least one acidic precursor chosen from aluminium sulfate, aluminium chloride, aluminium nitrate, sulfuric acid, hydrochloric acid and nitric acid, in which at least one of the basic or acidic precursors comprises aluminium, the relative flow rates of the acidic and basic precursors are chosen so as to obtain a pH of the reaction medium of between 8.5 and 10.5 and the flow rates of the acidic and basic precursor or precursors containing aluminium are adjusted so as to obtain a degree of progression of the second stage of between 87% and 95%, the degree of progression being defined as being the proportion of alumina formed as Al₂O₃ equivalent during the said second precipitation stage, with respect to the total amount of alumina formed on conclusion of stage a3) of the preparation process, the said stage being carried out at a temperature of between 40 and 90° C. and for a period of time of between 2 minutes and 50 minutes;
a4) a stage of filtration of the suspension obtained on conclusion of the second precipitation stage a3) in order to obtain an alumina gel;
a5) a stage of drying the said alumina gel obtained in stage a4) in order to obtain a powder;
a6) a stage of heat treatment of the powder obtained on conclusion of stage a5) at between 500 and 1000° C., for a period of time of between 2 and 10 h, in the presence or absence of a stream of air containing up to 60% by volume of water, in order to obtain a calcined porous aluminium oxide.

12. Process according to claim 1, in which the said calcined porous aluminium oxide according to stage a) is obtained by the following stages:
a1′) a stage of dissolving an acidic aluminium precursor chosen from aluminium sulfate, aluminium chloride and aluminium nitrate in water, at a temperature of between 20 and 90° C., at a pH of between 0.5 and 5, for a period of time of between 2 and 60 minutes,
a2′) a stage of adjustment of the pH by addition, to the suspension obtained in stage a1′), of at least one basic precursor chosen from sodium aluminate, potassium aluminate, ammonia, sodium hydroxide and potassium hydroxide, at a temperature of between 20 and 90° C. and at a pH of between 7 and 10, for a period of time of between 5 and 30 minutes,
a3′) a stage of coprecipitation of the suspension obtained on conclusion of stage a2′) by addition, to the suspension, of at least one basic precursor chosen from sodium aluminate, potassium aluminate, ammonia, sodium hydroxide and potassium hydroxide and of at least one acidic precursor chosen from aluminium sulfate, aluminium chloride, aluminium nitrate, sulfuric acid, hydrochloric acid and nitric acid, at least one of the basic or acidic precursors comprising aluminium, the relative flow rates of the acidic and basic precursors being chosen so as to obtain a pH of the reaction medium of between 7 and 10 and the flow rates of the acidic and basic precursor or precursors containing aluminium being adjusted so as to obtain a final concentration of alumina in the suspension of between 10 and 38 g/l,
a4′) a stage of filtration of the suspension obtained on conclusion of the coprecipitation stage a3′) in order to obtain an alumina gel,
a5′) a stage of drying the said alumina gel obtained in stage a4′) in order to obtain a powder,
a6′) a stage of heat treatment of the powder obtained on conclusion of stage a5′) at a temperature of between 500 and 1000° C., in the presence or absence of a stream of air containing up to 60% by volume of water, for a period of time of between 2 and 10 hours, in order to obtain a calcined porous aluminium oxide.

13. Process according to claim 1, in which the said calcined porous aluminium oxide according to stage a) is obtained by the following stages:
a1″) at least one first stage of precipitation of alumina, in an aqueous reaction medium, from at least one basic precursor chosen from sodium aluminate, potassium aluminate, ammonia, sodium hydroxide and potassium hydroxide and from at least one acidic precursor chosen from aluminium sulfate, aluminium chloride, aluminium nitrate, sulfuric acid, hydrochloric acid and nitric acid, in which at least one of the basic or acidic precursors comprises aluminium, the relative flow rates of the acidic and basic precursors are chosen so as to obtain a pH of the reaction medium of between 8.5 and 10.5 and the flow rates of the acidic and basic precursor or precursors containing aluminium are adjusted so as to obtain a degree of progression of the said first stage of between 40% and 100%, the degree of progression being defined as being the proportion of alumina formed as Al₂O₃ equivalent during the said first precipitation stage, with respect to the total amount of alumina formed on conclusion of stage c) of the preparation process, the said first precipitation stage being carried out at a temperature of between 10 and 50° C. and for a period of time of between 2 minutes and 30 minutes;
a2″) a stage of heat treatment of the suspension heated at a temperature of between 50 and 200° C. for a period of time of between 30 minutes and 5 hours, making it possible to obtain an alumina gel;
a3″) a stage of filtration of the suspension obtained on conclusion of the heat treatment stage a2″), followed by at least one stage of washing the gel obtained;
a4″) a stage of drying the alumina gel obtained on conclusion of stage a3″) in order to obtain a powder;
a5″) a stage of heat treatment of the powder obtained on conclusion of stage a4″) at a temperature of between 500 and 1000° C., in the presence or absence of a stream of air containing up to 60% by volume of water, in order to obtain a calcined porous aluminium oxide.

14. Process for the selective hydrogenation of polyunsaturated compounds containing at least 2 carbon atoms per molecule, such as diolefins and/or acetylenics and/or alkenylaromatics, present in a hydrocarbon feedstock having a final boiling point of less than or equal to 300° C., which process being carried out at a temperature of between 0 and 300° C., at a pressure of between 0.1 and 10 MPa, at a hydrogen/(polyunsaturated compounds to be hydrogenated) molar ratio of between 0.1 and 10 and at an hourly space velocity of between 0.1 and 200 h⁻¹ when the process is carried out in the liquid phase, or at a hydrogen/(polyunsaturated compounds to be hydrogenated) molar ratio of between 0.5 and 1000 and at an hourly space velocity between 100 and 40 000 h⁻¹ when the process is carried out in the gas phase, in the presence of a catalyst obtained according to claim 1.

15. Process for the hydrogenation of at least one aromatic or polyaromatic compound present in a hydrocarbon feedstock having a final boiling point of less than or equal to 650° C., the said process being carried out in the gas phase or in the liquid phase, at a temperature of between 30 and 350° C., at a pressure of between 0.1 and 20 MPa, at a hydrogen/(aromatic compounds to be hydrogenated) molar ratio between 0.1 and 10 and at an hourly space velocity HSV of between 0.05 and 50 h⁻¹, in the presence of a catalyst obtained according to claim 1.
